(19) United States
(12) Patent Application Publication
(10) Pub. No.: US 2012/0096070 A1
(43) Pub. Date: Apr. 19, 2012

(54) WEB APPLICATION FRAMEWORK REMOTING MODEL API

(76) Inventor: Shane Bryzak, Daisy Hill QLD (AU)

(21) Appl. No.: 12/905,344

(22) Filed: Oct. 15, 2010

(51) Int. Cl. G06F 15/16

(52) U.S. Cl. 709/203

(57) ABSTRACT

A client creates a client model for a persistence context based on first model data that is received from a server in a first operation between the client and the server, the client model being a representation of a model that resides on the server and comprising an initialized model property and an uninitialized model property. The client expands the client model by assigning a value to the uninitialized model property based on at least second model data that is received from the server in at least a second operation between the client and the server within the same persistence context.

### TECHNICAL FIELD

Embodiments of the present invention relate to supporting development of web applications. Specifically, the embodiments of the present invention relate to a client expanding a client-side object model via incremental changes to enable remote updates to a server-side managed object model.

### BACKGROUND

AJAX (Asynchronous JavaScript and XML) is a technique for developing highly interactive web applications that use client-side scripting to exchange data with a web server. Users, such as web application developers, can use AJAX to create web pages that can be dynamically updated without a full web page refresh interrupting the interaction flow. For example, a shopper can browse an on-line bookstore and select a book to add to an on-line shopping cart. The on-line bookstore may have AJAX incorporated into its web application, such that a shopper can continue to browse the on-line bookstore for other books while adding items to his/her shopping cart without having to wait after each click for a full web page update.

Web application developers can use a development tool that provides a framework for designing dynamic websites, web applications, and web services. An example of a web application framework tool is Seam, which uses an open source development platform for building Internet applications in Java. Seam provides built-in support for AJAX and provides a separate technology called Seam Remoting that allows a method (subroutine) on Seam components to be executed directly from JavaScript code running within a web browser.

Virtually all applications use some form of ‘persistence,’ in other words, applications save information for a particular context for future execution. The information can be used until the particular context ends. Examples of a persistence context can include, and are not limited, to stateless contexts, event (or request) contexts, page contexts, conversation contexts, session contexts, business process context, and application contexts. Persistence is particularly critical for web applications which frequently integrate user interaction and conversation contexts are particularly pertinent to web applications.

A ‘conversation’ is a unit of work from the point of view of a user and can span several interactions with the user, several requests, and several database transactions. To the user, a conversation solves a single problem. For example, for a user that is a web application developer, edit customer data can be an example of a conversation. In another example, for a user that is facilitating an on-line transaction, book hotel, approve contract, create order are examples of conversations. A conversation holds state information associated with what a user is doing for a conversation. A single user may have multiple conversations in progress at any point in time. The conversation context for a conversation allows a framework tool to ensure that the state from the different conversations does not collide and cause errors. Some conversations can last for a single request. Conversations that span multiple requests can be demarcated using annotations provided by the framework tool.

A web application server can save state information by managing data for a persistence context. Data for a ‘server-side managed persistence context’ can include an object data model (object model) on the server. The ‘server-side object model’ can include a persistent object graph (server-side persistent object graph), which is a view of an object system at a particular point in time. An object graph relates instances between objects. AJAX-based web applications can save information from data at a web browser hosted by a client by sending the data to a server. The server can receive the data from the client and update its persistent object graph to maintain current state information.

There has been a long standing problem with how AJAX-based web applications interact with server-side persistent object graphs, specifically with the way that modifications made to objects by a client are applied to the persistent state of the objects on the server. In a ‘traditional’ AJAX-based web application, a client typically applies modifications to the persistent objects in a server-side persistent object graph via a Remote Procedure Call (RPC)-style operation in which the server-side persistent object graph is updated in a programmatic fashion, such as on a function by function basis. A client must send a request for all of the data that a web application developer intends to work with in a single operation to the server and subsequently, update the server-side persistent object graph in a single update operation. However, this conventional programmatic manner is often inconvenient because a web application developer may not initially know all of the data he/she intends to work with.

In addition, when a client fetches only a partial object graph of the server-side persistent object graph from a server, the remaining portion of the object graph in the client is left in an ‘undefined’ state. A web developer, thus, is limited to working with only the data that is identified in the single request operation and does not have the ability to further work with additional data on the client.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 is an exemplary network architecture in which embodiments of the present invention may operate.

FIGS. 2A-2C illustrate exemplary database objects, according to one embodiment of the invention.

FIG. 3 is an exemplary fetch request, according to one embodiment of the invention.

FIG. 4 is an exemplary fetch response, according to one embodiment of the invention.

FIG. 5 is a block diagram of one embodiment of a model remoting system for creating and expanding a client-side model via incremental changes and multiple operations (e.g., fetch operation, expand operation) to enable remote updates to a server-side model using a single update operation within the same persistence context.

FIG. 6 is exemplary user input for creating and defining a model, according to one embodiment of the invention.

FIG. 7 is a block diagram of one embodiment of a model updating system for enabling incremental changes to expand a client-side model within a same persistence context and applying remote updates to a server-side model in a single update operation within the same persistent context.

FIG. 8 is a flow diagram of an embodiment of a method of a client expanding a client-side model within a same persistence context and invoking remote updates to a server-side model within the same persistence context.

FIG. 9 is a flow diagram of an embodiment of a method of a server servicing client requests to expand a client-side model and to apply remote updates to a server-side model.

FIG. 10 is a flow diagram of an embodiment of a method for a client defining model data to be fetched from a server to create a client-side model.

FIG. 11 is a flow diagram of an embodiment of a method for a server servicing a fetch request from a client for retrieving model data.

FIG. 12 is a flow diagram of an embodiment of a method for creating a client-side model.

FIG. 13 is a flow diagram of an embodiment of a method for sending a request to a server for additional model data for expanding a client-side model.

FIG. 14 is an exemplary expand request, according to one embodiment of the invention.

FIG. 15 is a flow diagram of an embodiment of a method for servicing an expand request from a client for expanding a client-side model within a same persistence context.

FIG. 16 is an exemplary expand response, according to one embodiment of the invention.

FIG. 17 is a flow diagram of an embodiment of a method for expanding a client-side model within a same persistence context.

FIG. 18 is a flow diagram of an embodiment of a method for applying updates to a server-side model.

FIG. 19 is exemplary code for implementing an algorithm for creating an object delta, according to one embodiment of the invention.

FIG. 20 is an exemplary update request, according to one embodiment of the invention.

FIG. 21 is a flow diagram of an embodiment of a method for servicing an update request from a client for updating a server-side model.

FIG. 22 is a diagram of one embodiment of a computer system for enabling a client to expand a client-side model within a same persistence context and to remotely apply updates to a server-side model within the same persistence context.

### DETAILED DESCRIPTION

Embodiments of the invention are directed to a method and system for enabling a client to expand a client-side managed persistence context (e.g., a client-side object model) and to remotely apply changes to a server-side managed persistence context (e.g., a server-side object model) within the same persistence context. A client creates a client model for a persistence context based on first model data that is received from a server in a first operation between the client and the server, the client model being a representation of a model that resides on the server and comprising an initialized model property and an uninitialized model property. The client expands the client model by assigning a value to the uninitialized model property based on at least second model data that is received from the server in at least a second operation between the client and the server within the same persistence context.

A web application server can save and maintain state information for a particular persistence context (e.g., conversation context). Data for a server-side managed persistence context can include an object data model (object model) on the server. The server-side object model (also hereinafter referred to as ‘server-side model’) can include a persistent object graph (also hereinafter referred to as ‘server-side persistent object graph’ or ‘server-side object graph’), which is a view of an object system at a particular point in time.

A client, which hosts AJAX-based web applications and a web browser, can have a client representation of the server-side model for a particular persistence context, hereinafter referred to as ‘client-side object model’ or ‘client-side model). The client-side model can include a representation of a server-side object graph, hereinafter referred to as ‘client-side persistent object graph’ or ‘client-side object graph’. The client can make changes to the client-side object graph and can save data reflecting the changes made to the client-side object graph and send the data to a server. The server can receive the data from the client and update its persistent object graph to maintain current state information to help maintain consistent states with the client.

Traditionally, when a user wishes to apply any changes made to a client-side object graph to a server-side object graph, the user has to submit a single request for all of the data he/she intends to work with up front and has to manually provide changes for a server-side object graph in a programmatic fashion by initiating a single update operation. This traditional manner does not allow a user to further expand a client-side object graph within the same persistence context and to make changes to the server-side object model within the same persistence context. Embodiments of the present invention enable a client to create a client-side object model for a particular persistence context and expand the client-side object model within the same persistence context. Embodiments of the present invention enable remote changes to a server-side object model for the same persistence context by providing new operations for interacting with the server-side object model, such as a fetch operation, an expand operation, and an update operation. An ‘operation’ used herein refers to a client sending a request to a server and receiving a response from a server.

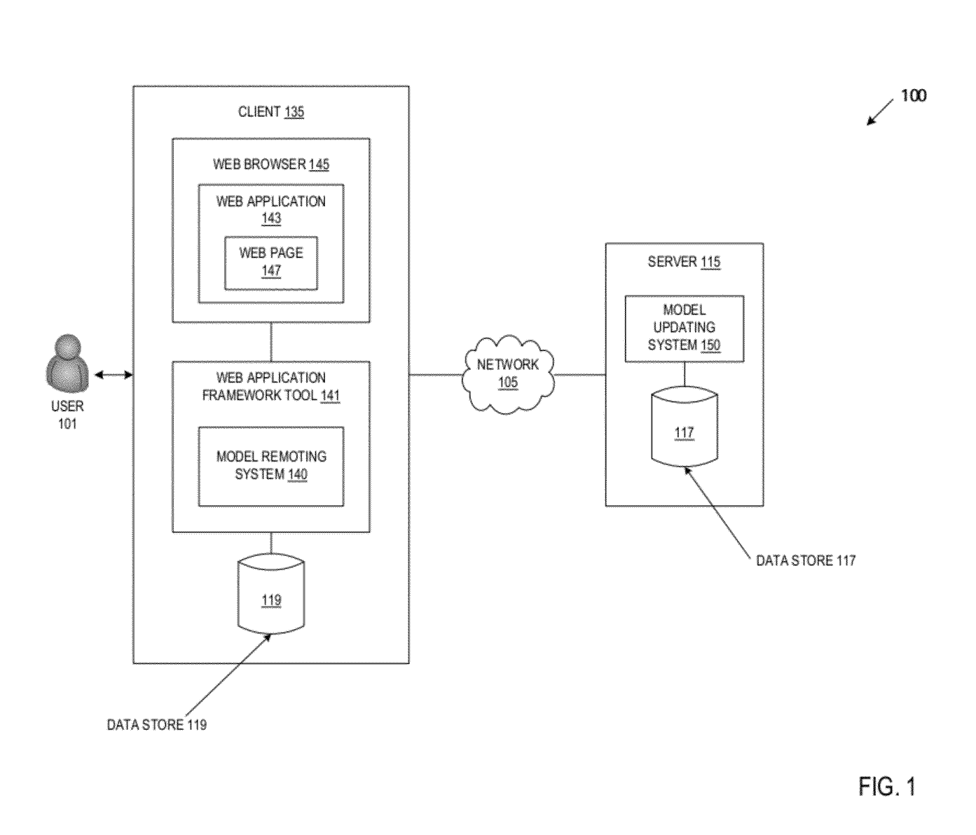

FIG. 1 is an exemplary network architecture 100 in which embodiments of the present invention can be implemented. The architecture 100 includes one or more servers 115 that can communicate with one or more clients 135 using network 105. A server 115 can be any type of computing device including server computers, desktop computers, laptop computers, gateway computers, or similar computing device. A client 135 can be any type of computing device including desktop computers, laptop computers, mobile communications devices, cell phones, smart phones, hand-held computers or similar computing device. The network 105 can be a public network (e.g., Internet) or a private network (e.g., a local area network (LAN)). A data store 117,119 can be a persistent storage unit. A persistent storage unit can be a local storage unit or a remote storage unit. Persistent storage units can be a magnetic storage unit, optical storage unit, solid state storage unit, electronic storage units (main memory), or similar storage unit. Persistent storage units can be a monolithic device or a distributed set of devices. A ‘set’, as used herein, refers to any positive whole number of items

A server 115 can store information in a database in a data store 117. The server 115 can be a web application server that hosts a web application 143 accesible by a user 101 via a web browser 145 hosted by a client 135. The datastore 117 can be, for example, a customer database, that stores personal information for a number of customers (e.g., last name, first name, date of birth, address, etc.).

AJAX is a technique for developing highly interactive web applications 143 that use client-side scripting, for example, stored in a data store 119 that is coupled to the client 135 and executed by a web page 147 to exchange data with the web server 115. Users 101, such as web application developers, can use AJAX to create an AJAX-based web application 143 that includes web pages 147 that can be dynamically updated without a full web page 147 refresh interrupting the interaction flow. For example, an AJAX-based web application 143 can be an on-line bookstore, and a shopper can browse the on-line bookstore and select a book to add to an on-line shopping cart. The shopper can continue to browse the on-line bookstore web pages 147 for other books while adding items to his/her shopping cart without having to wait after each click for a full web page 147 update.

Client(s) 135 can include a web application framework tool 141 for providing a web framework to a user 101, such as a web application developer, for designing dynamic websites, web applications, and web services. An example of a web application framework tool 141 is Seam, which uses an open source development platform for building Internet applications in Java. The tool 141 can integrate web technologies such as AJAX, JavaServer Faces (JSF), Enterprise Java Beans (EJB 3.0), etc., into a unified solution and enables web application developers 101 to assemble complex web applications 143. The web application framework tool 141 can use client libraries that are stored in a data store 119 to remotely interact with a data that is stored on a data store 117 that is coupled to the server 115. An example of a client library is an AJAX-based client library that allows a web application 143 to retrieve data from a server 115 asynchronously in the background without interfering with the presentation and performance of a web page 141.

A web application 143 can use some form of ‘persistence’, in other words, a web application 143 can save state information for a particular context for future execution. The state information can be used until the particular context ends. Examples of a persistence context can include, and are not limited to, stateless contexts, event (or request) contexts, page contexts, conversation contexts, session contexts, business process context, and application contexts. Persistence is particularly important to web applications 143 which frequently integrate user 101 interaction. For brevity and simplicity, a conversation context is used as an example of a persistence context throughout this document. However, embodiments of the invention can be implemented with other types of persistence context.

A conversation is a unit of work from the point of view of the user 101 and can span several interactions with the user 101, several requests between a client 135 and a server 115, and several database 117 transactions. To the user 101, a conversation solves a single problem. For example, for a user 101 that is a web application developer, edit customer data in the customer database can be an example of a conversation. A conversation holds state information associated with what a user is doing for the conversation. A single user 101 may have multiple conversations in progress at any point in time. Some conversations can last for a single request. Conversations that span multiple requests can be demarcated using annotations provided by the framework tool 141.

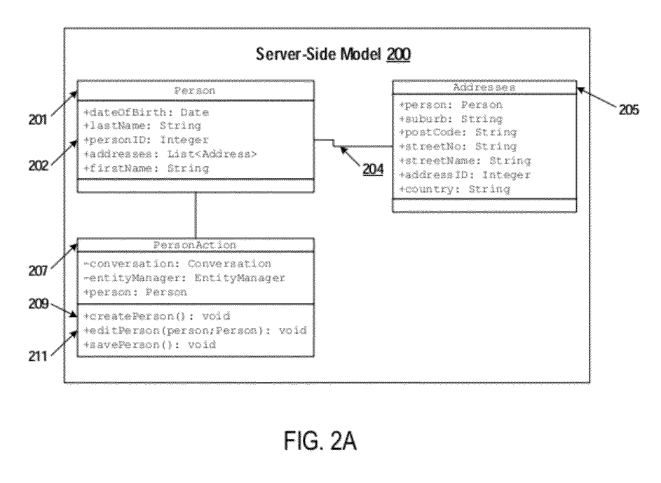

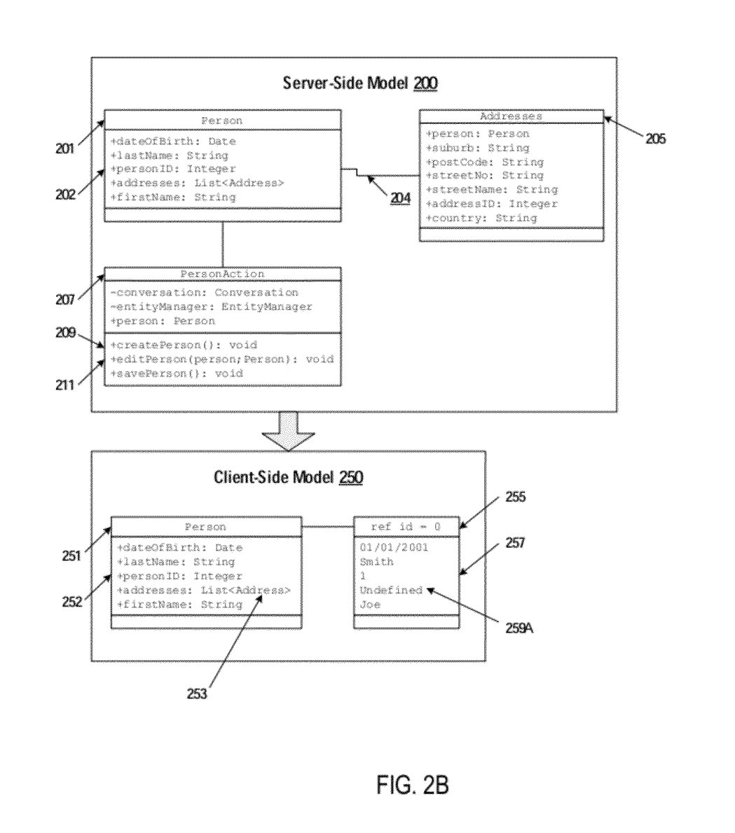

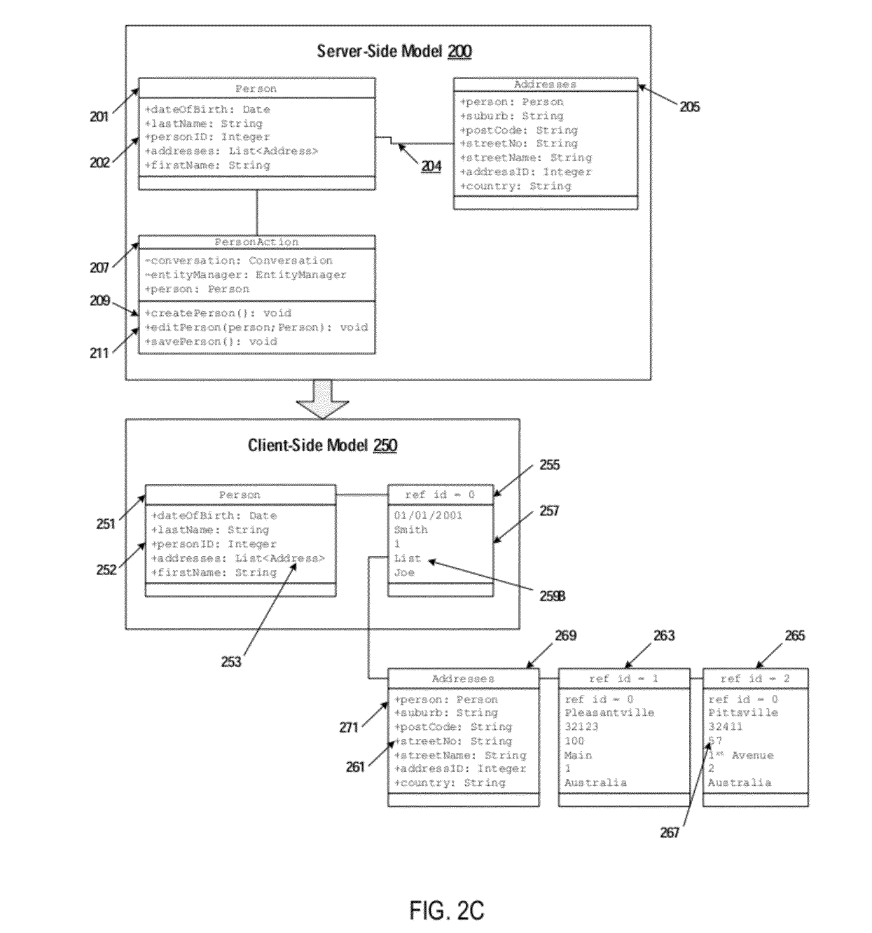

The conversation context for a conversation allows a framework tool 141 to ensure that the state from the different conversations does not collide and cause errors. A web application server 115 can save state information by managing data for a persistence context (e.g., conversation context) in the data store 117. Data for a server-side managed persistence context can include an object model on the server. The server-side object model can include a persistent object graph, which relates instances between objects and can include branches and nodes. For example, a server-side model for a customer database can include a Person object. The Person object can have model properties, such as Last Name, First Name, and Address. A model property can have its own properties and an object graph can include an object representing a model property. For example, Address can have its own properties, such as, suburb and post code. FIG. 2A illustrates an exemplary portion of a server-side persistent object graph illustrating a Person object 201 and an Addresses object 205, according to one embodiment of the invention. The Person object 201 and Addresses object 205 can also be referred to as nodes. The relationship between the Person object 201 and the Addresses object 205 can be represented by a branch 204. The Person object 201 has model properties 202 (e.g., dateOfBirth, lastName, personId, addresses, firstName). A model property 202 of the Person object 201 can also have its own properties. For example, the addresses property 203 of the Person object 201 has its own properties 205 (e.g., person property, suburb property, postCode property, etc.). Returning to FIG. 1, the server-side object model and server-side object graph can be stored in data store 117.

A client 135, which hosts an AJAX-based web application 143, can request model data for a particular persistence context (e.g., conversation context) from the server 115 to create an object model on the client (client-side model) that is a representation of the server-side object model for the particular persistence context. The client-side model can include a representation of a server-side object graph, also referred to as ‘client-side persistent object graph’ or ‘client-side object graph.’ The client-side model and client-side object graph can be stored in the data store 119.

The client 135 can receive user input from the user 101 and change the client-side model, via the client-side object graph, based on the user input. For example, a user 101 can provide user input to edit a customer's personal information in a customer database 117 via the client-side model. The client 135 can save data reflecting the changes made to the client-side object graph in data store 119. It is important for a client 135 and a server 115 to maintain consistent state information for a persistence context, to help prevent a server 115 from processing web application requests using stale data. Thus, when a user 101 completes changing to the client-side object graph in data store 119, the a client 135 provides data to a server 115 via the network 105. The server 115 can receive the data from the client 135 and can update its persistent object graph to maintain current states with the client 135.

Traditionally, when a user 101 wishes to apply the changes made to the client-side model to the objects in the server-side object model (e.g., objects in the server-side persistent object graph in the server-side object model), the user 101 has to submit a single request for all of the data he/she intends to work with up front and has to manually provide changes for a server-side model in a programmatic fashion by initiating a single update operation. This traditional manner does not allow a user 101 to further expand a client-side model within the same persistence context and to make changes to the server-side model within the same persistence context.

The web application framework tool 141 (e.g., Seam framework tool) can include a model remoting system 140 for creating a client-side model for a particular persistence context and for expanding the client-side object model via incremental changes within the same persistence context. The model remoting system 140 can also enable remote changes to a server-side object model using a single update operation within the same persistence context. As noted above, an ‘operation’ can refer to a client sending a request to a server and receiving a response from a server. A client 135 can maintain a client-side model representation of the server-side model for a particular persistence context in the data store 119 and the model remoting system 140 hosted by the framework tool 141 (e.g., Seam) allows a user 101 to expand the client-side model using multiple operations (e.g., fetch operation, expand operation) within the same persistence context. A user 101 is also enabled to to make changes to the server-side object model within the same persistence context via a single update operation, rather than applying all of the changes to the server-side model in multiple discrete operations.

The server 115 can include a model updating system 150 that can provide model data for a particular persistence context to the client 135 to allow the client 135 to create a client-side model for the persistence context (e.g., via a fetch operation). The model updating system 150 can be implemented as a bean in the server 115. The model updating system 150 can provide additional model data for the same persistence context, but in a different operation (e.g., an expand operation), to the client 135 to allow the client 135 to expand the client-side model for the same persistence context. The model updating system 150 can receive data from the client 135 in a single operation (e.g., update operation) to implement updates to the server-side model to reflect the changes a user 101 makes to the client-side model all within the same persistence context (e.g., conversation context).

The model remoting system 140 and the model updating system 150 provide new operations for a client 135 to interact with a server-side model, such as a fetch operation, an expand operation, and an update operation. The model remoting system 140 hosted by a client 135 can send a fetch request to the server 115 in a first request operation to obtain model data for the server-side model for a particular persistence context (e.g., conversation context). As described above, FIG. 2A illustrates an exemplary portion of a server-side persistent object graph illustrating a Person object 201 and an Addresses object 205, according to one embodiment of the invention. For example, a user 101 wishes to make changes to a Person record in a customer database 117. The model remoting system 140 can send a fetch request to the server 115 in a first request operation to obtain model data for the server-side model 200 for a conversation context to edit an existing customer instance (e.g., Person record) in a customer database. The fetch request can include data that identifies the model properties to be fetched. Since the conversation context is to edit an existing customer instance in the customer database, the fetch request can be for fetching only the Person object 201 for the server-side model 200 to create a client-side model. The model remoting system 140 can receive the model data in a fetch response from a sever 115 and load the Person record for a user 101 to edit via a web browser 145.An exemplary portion of a client-side model is described in greater detail below in conjuction with FIG. 2B. Subsequently, the user 101 may realize that he/she needs to also change one of the Person's addresses in the customer database 117. The user 101 wishes to view the Person's addresses for editing and thus, the client 135 expands a client-side model by requesting the Address object 205 by sending an expand request to the server 115 to fetch the address records. The model remoting system 140 can receive the model data in an expand response from a sever 115 and append the address records to the Person object of the client-side model. An exemplary portion of an expanded client-side model is described in greater detail below in conjuction with FIG. 2C.

Returning to FIG. 2A, the server-side model 200 includes action property called PersonAction 207, which is responsible for creating and editing customer instances, for example with a createPerson method 209 and an editPerson method 211. The model remoting system 140 hosted by the client 135 can create and send a fetch request to fetch the PersonAction.person property, and to invoke the editPerson method 211 when the model data is fetched. The fetch request, therefore, can specify the action (e.g., editPerson 211) to be invoked by the server 115. In this example, a user 101 can provide user input specifying the PersonID that the user wishes to edit. The model remoting system 140 can receive the user input and include an action method parameter in the fetch request.

The model updating system 150 hosted by the server 115 can receive the fetch request from the client 135 and create and send a response (fetch response) to the client 135 that includes model data for the requested model properties (e.g., Person object 200) for creating the client-side model. When the model updating system 150 receives the fetch request, the server can first invoke the action, if any, that is specified in the fetch request (e.g., editPerson) before the model updating system 150 reads the property values for the requested model properties (e.g., properties 202), and returning the model data that includes the model property values to the client 135. Model data can include a unique model identifier, model properties, and property values for one or more of the model properties.

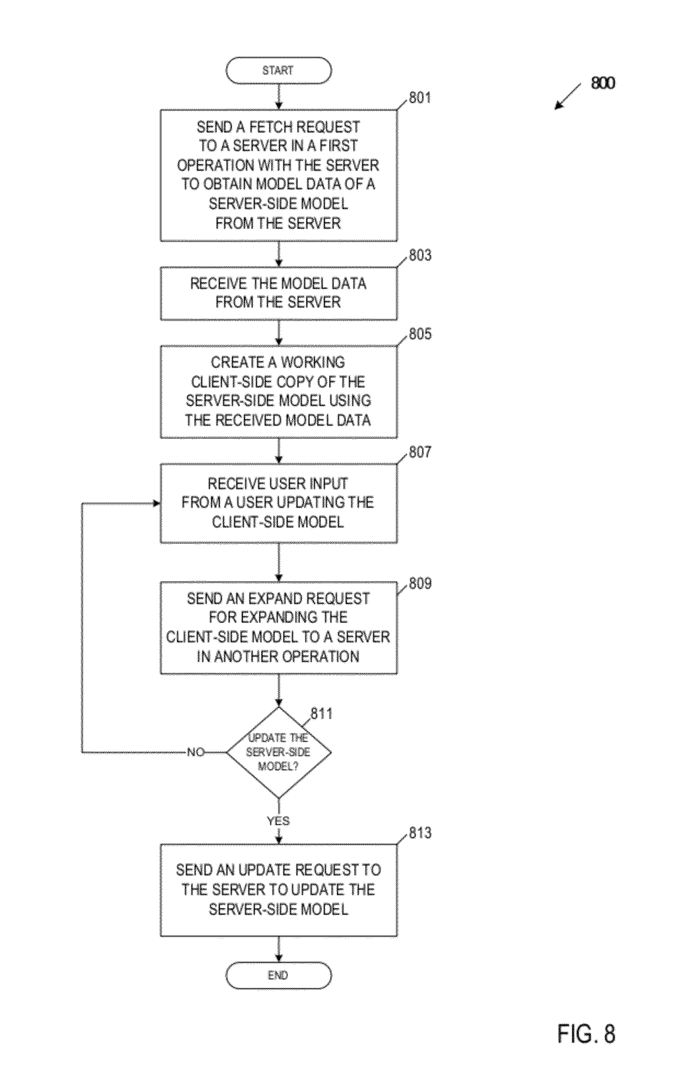

FIG. 2B illustrates an exemplary portion of a server-side persistent object graph for a server-side model 200 and an exemplary portion of a client-side persistent object graph for a client-side model 250 created by a client based on model data received in a fetch response from a server, according to one embodiment of the invention. The model remoting system 140 can receive a fetch response that includes model data from the server 115 and create a client-side model 250 as a working copy of the server-side model 200 based on the model data. The model data in the fetch response can include a unique model identifier, model properties, and property values for one or more of the model properties. One embodiment of a method for receiving a fetch response and creating a client-side model for a conversation context is described in greater detail below in conjuction with FIG. 8.

The fetch request sent by the client 135 to the server 115 may have specified the customer instance that the user wishes to edit. For example, the fetch request may have specified a customer instance having a PersonID of <ref ID=“0”> and the server 115 can send a fetch response to the client 135 that includes property values for the PersonID having <ref ID=“0”>. The client-side model 250 includes a client-side persistent object graph illustrating a Person object 251. The Person object 251 has model properties 252 (e.g., dateOfBirth, lastName, personld, addresses, firstName). The client-side model 250 includes an object instance 255 to represent a customer instance having PersonID of <ref ID=“0”>. The object instance 255 has property values 257.

In this example, the fetch request may have fetched only a Person object 201 from the server-side model 200, and the model updating system 150 hosted by the server 115 may have sent model data for only a partial object graph to the client 135. Thus, some model properties 252, such as addresses 253, in the client-side object graph for the client-side model 250 may not be initialized with data for object instances, such as for object instance 255. The corresponding address property value 259A for object instance 255 is in an undefined state. A user 101 may wish to change (e.g., expand) the client-side model 250 (e.g., expand the addresses property 253 for object instance 255) in order to work with uninitialized properties. The model remoting system 140 hosted by the client 135 can receive user input to create and send an expand request to the server 115 for expanding (initializing) the addresses property 253 for the object instance 255 having <ref id=“0”> within the same persistence context. The model updating system 150 hosted by the server 115 can receive the expand request and create and return an expand response that includes model property data for the addresses property 253 corresponding to the object instance 255.

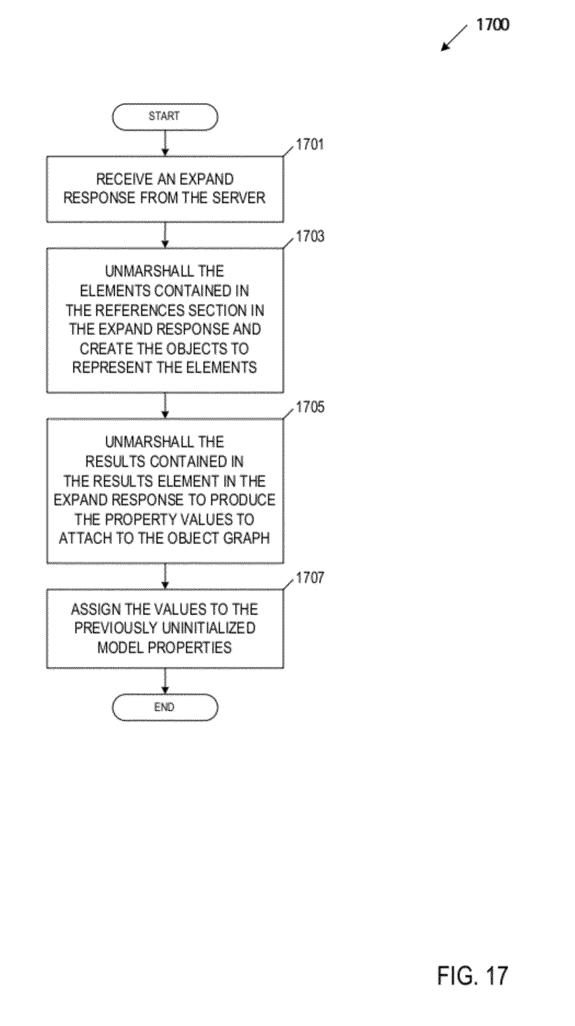

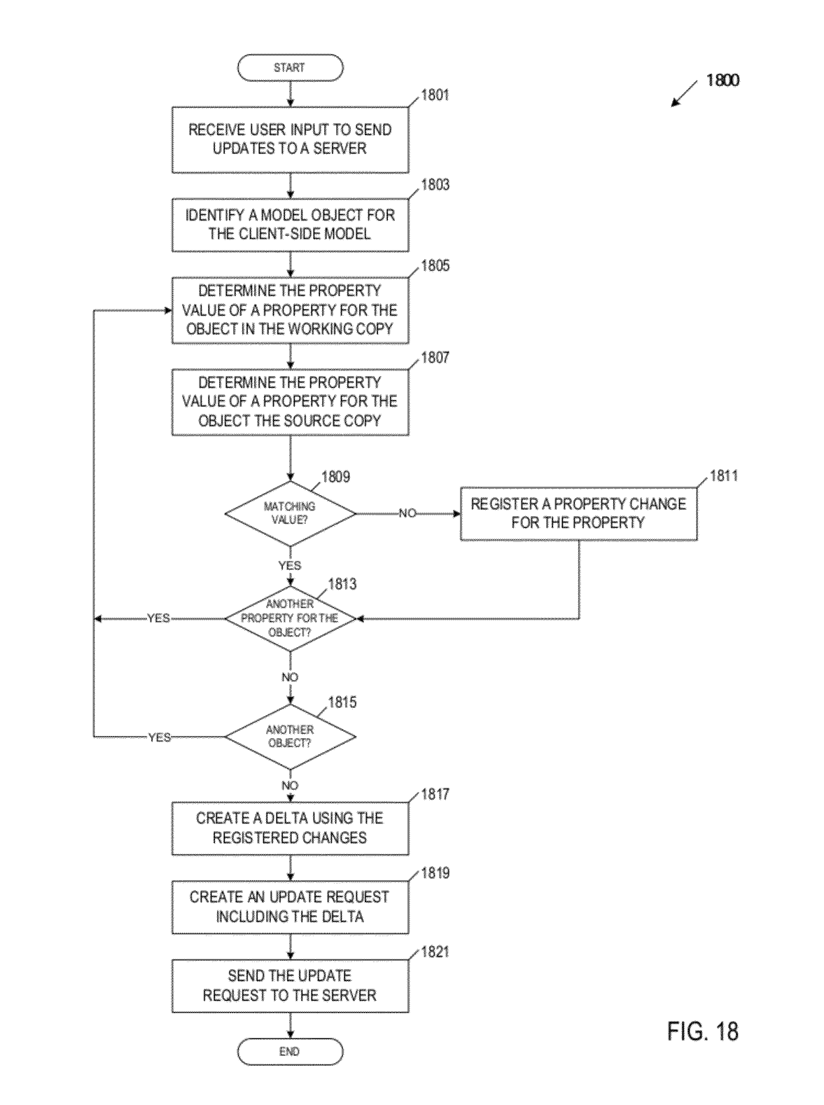

FIG. 2C illustrates an exemplary portion of a client-side persistent object graph for a client-side model 250 expanded by a client within a same persistence context based on model data received in an expand response from a server, according to one embodiment of the invention. The model remoting system 140 can receive an expand response that includes model data from the server 115 to expand (initialize) the addresses property 253 corresponding to the object instance 255. One embodiment of a method for receiving an expand response and expanding a client-side model for a conversation context based on the data in the expand response is described in greater detail below in conjuction with FIG. 17. The addresses property 259B for the object instance 255 is changed to a defined state (e.g., “List”). The client-side object graph is expanded by including an Addresses object 269 having model properties 271. The client-side object graph is expanded by also including two object instances 263,265 having property values for the addresses property 259B for the object instance 255. The customer database stores data for two addresses for customer “Joe Smith.” A user 101 is now allowed to modify the property values for the addresses object instances 263,265. A user 101 can make changes to the property values in client-side model 250 and may wish to apply the changes to the server-side model 200. For example, a user 101 may change the address property value 267 for the streetNo property 261 corresponding to the object instance 265 from “57” to “576”. The model remoting system 140 can create and send an update request to the server 115 to apply these changes to the server-side model 250. One embodiment of a method for creating and sending an update request for a conversation context to a server is described in greater detail below in conjuction with FIG. 18.

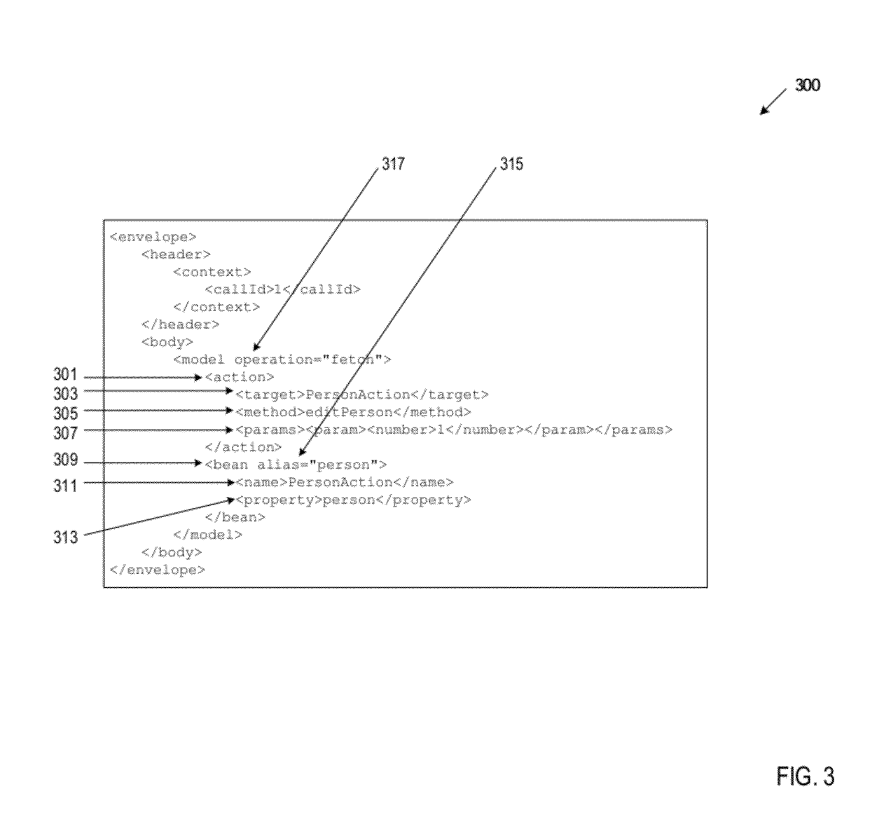

FIG. 3 is an exemplary fetch request 300 utilizing the XML protocol that is sent by a client to a server to request model data for a client-side model within a same persistence context, according to one embodiment of the invention. The request type is identified by a model operation parameter 317 that can be included in the request. The fetch request 300 contains a list specifiying the model properties (server-side model properties) that are to be fetched in one or more bean elements 309 (e.g., /envelope/body/model/bean). Request 300 identifies a Person 313 model property to be fetched. A bean element 309 consists of an alias 315, a class name 311, and a property name 313. The request 300 can specify an action for invoking a server-side method when the server-side model properties are fetched. For example, the action can consist of code that initializes the property values which a user wishes to interact with in the client-side model. If the request specitifes an action, the action can be in an action element 301. The action element 301 contains the name of the target class 303 to be invoked, the method 305 (e.g. editPerson) to invoke on the target class 303, and any specified parameter values 307 to be passed to the action method 305. In this example, the fetch request 300 includes an action for the server to edit an existing Person instance and a parameter value 307 specifying which Person instance is to be edited.

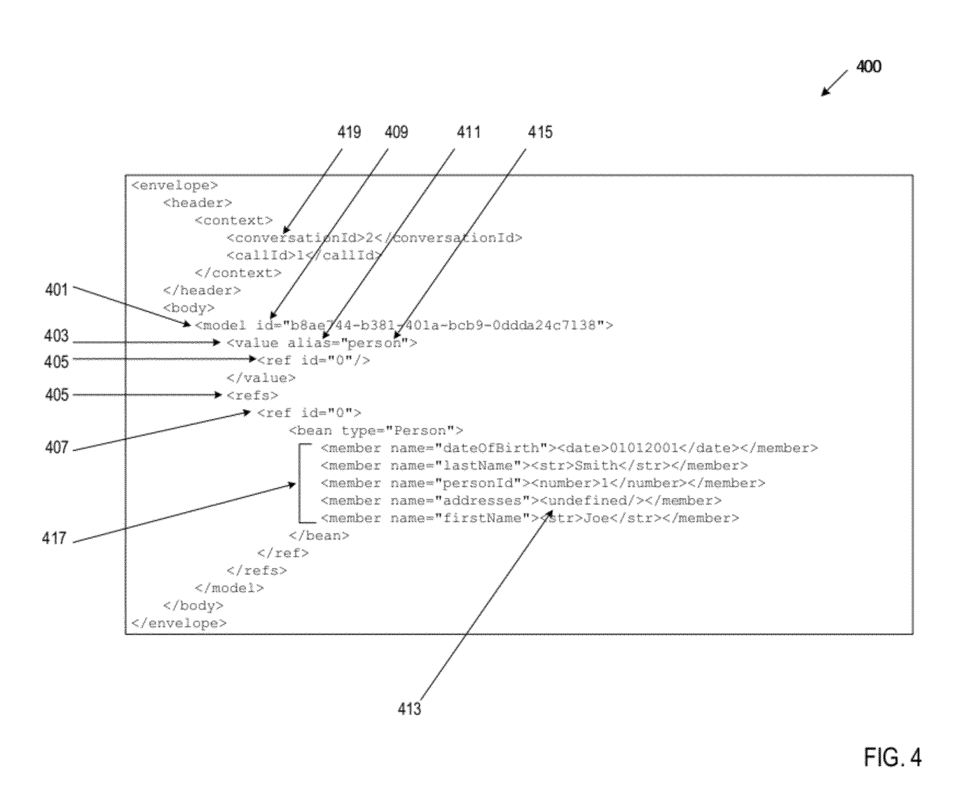

FIG. 4 is an exemplary fetch response 400 utilizing the XML protocol that is sent by a server to a client and contains model data for a client-side model within a same persistence context, according to one embodiment of the invention. The fetch response 400 contains a serialized representation of the property objects and any other objects referenced (either directly or indirectly) by those objects. A fetch response 400 includes property objects for a requested property and model data for the property objects. Model data can include a context identifier 419 (e.g., a conversation identifier), a unique model identifier, property objects for a requested property, and property values 417 for the property objects. For example, the fetch request 300 in FIG. 3 identitifed a Person 313 model property to be fetched. Fetch response 400 includes a property object <ref id=“0”> 405 for the Person 403 model property, and property values 417 for the <ref id=“0”> 405 property object.

A model element 401 (e.g., /envelope/body/model) of the response packet serves as a wrapper around the model properties 405 and property values 417 that are sent to the client. The fetch response 400 includes an id attribute containing the unique context identifier 419, which can be used in subsequent client requests to identify to the server which persistence context (e.g., conversation context) a request pertains to. The fetch response 400 also includes an id attribute containing the unique model identifier 409, which can be used in subsequent client requests to identify to the server which model instance a request pertains to. A value element 403 (e.g., /envelope/body/model/value) includes one or more elements that contain the property values for the model properties which were requested by the client. Each value element has an alias attribute 411 that indicates which model property the value represents. Each value element can contain values, such as primitive literals (e.g., String, Number, Date, etc.), bags (e.g., an array or other type of collection of values), maps, which are collections of key:value pairs, complex user-defined objects, etc. User-defined objects can use a reference identifier 407 to identify the value. Each object's definition is contained in its own reference element 405 (e.g., /envelope/body/model), with the id attribute 407 of the element representing the unique identifier for that object.

A fetch response 400 may include model data for only a partial object graph, thus leaving certain object properties in a client-side object graph uninitialized. The uninitalized model properties in the client-side object graph are in an ‘undefined’ state. For example, the fetch response 400 includes the Person object 415 and the property values 417 for the dateOfBirth property, lastName property, personld property, addresses property, and firstName property for the Person object 415. The addresses 413 property is an uninitialized property and is, therefore, in an undefined state.

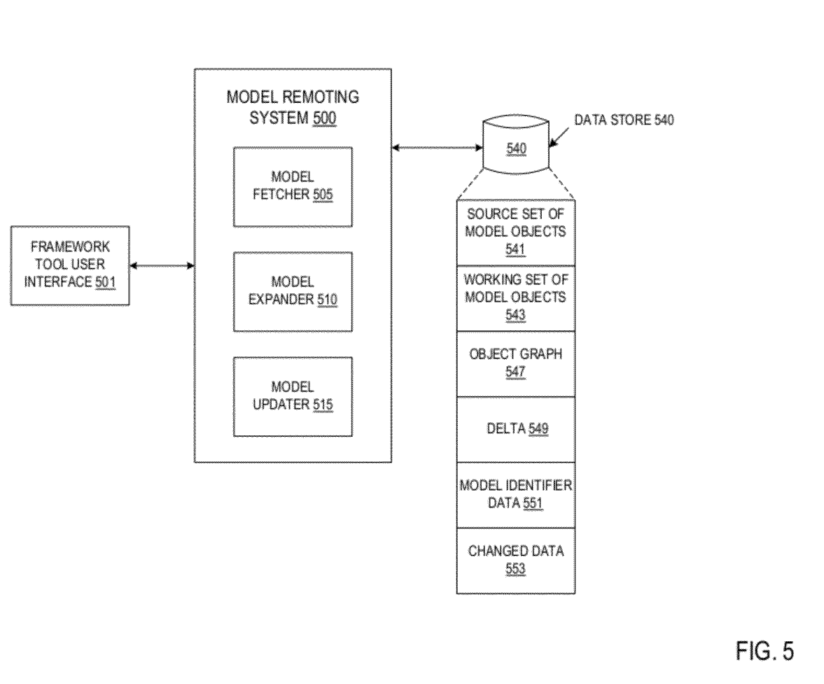

FIG. 5 is a block diagram of one embodiment of a model remoting system 500 for a client to create and modify (e.g., expand) a client-side model via incremental changes within the same persistence context and execute remote changes to a server-side model within a same persistence context. The model remoting system 500 may be the same as the model remoting system 140 hosted by a client 143 of FIG. 1. The model remoting system 500 can include a model fetcher 505, a model expander 510, and a model updater 515. The model remoting system 500 can be used with server-side objects that have a scope greater than the scope for a request (i.e., the server-side objects are expected to exist across multiple requests).

Users, such as web application developers, can use AJAX to create an AJAX-based web application that includes web pages that can be dynamically updated without a full web page refresh interrupting the interaction flow. Client(s) can include a web application framework tool for providing a web framework to a user, such as a web application developer, for designing dynamic websites, web applications, and web services. The framework tool can integrate web technologies such as AJAX, JavaServer Faces (JSF), Enterprise Java Beans (EJB 3.0), etc., into a unified solution and enable web application developers to assemble complex web applications.

The framework tool can include a model remoting system 500 to create a client-side object model that is a representation of a server-side object model for a particular persistence context (e.g., conversation context) via a fetch operation, to expand the client-side model within the same persistence context via an expand operation, to update the client-side model (e.g., modify the property values, such as address property values, in the client-side model), and to apply the updates to the server-side model via a single update operation, within the same persistence context.

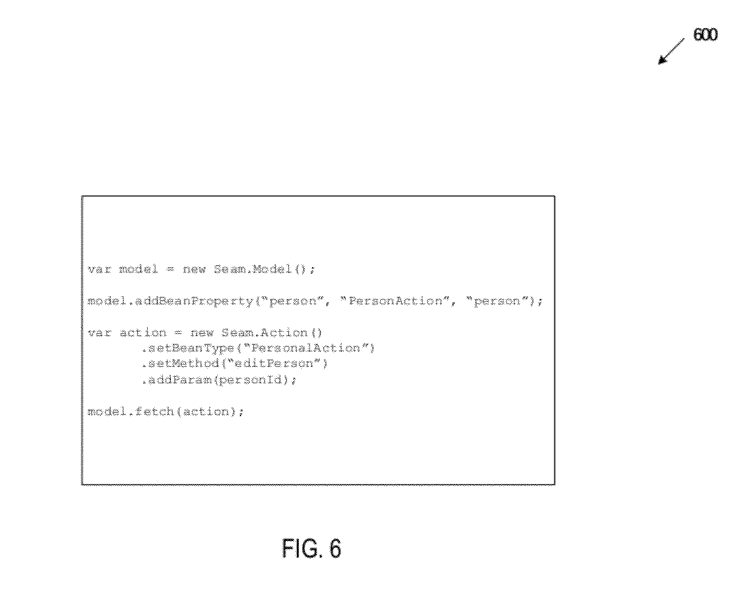

To initialize a server-side model and retrieve model data to create a client-side working represenation of the server-side model, a user provides user input specifying the properties of the server-side model to be fetched, and any action to be invoked on the server. The model fetcher 505 can receive user input (e.g., model properties to be fetched) to define a client-side model and can create a local instance of an empty model object to be stored in a data store 540 that is coupled to the system 500. This instance can be used to invoke all subsequent operations on the same client-side model. The user input can further specify an action for invoking a server-side method when the server-side model properties are fetched. For example, the action can consist of code that initializes the property values which a user wishes to interact with in the client-side model. User input can be remoting code written by a user or remoting code that is stored in a data store 540 and selected by a user. A user can use a framework tool user interface 501 to write or to select remoting code. The user interface 501 can be a graphical user interface. FIG. 6 is exemplary user input 600 for creating a new empty model object, defining which server-side model property objects are to be fetched from a server, and specifying an optional action be invoked, according to one embodiment of the invention.

Returning to FIG. 5, the model fetcher 505 can use the user input to create a fetch request to be sent to the server. The model fetcher 505 can format the fetch request utilizing the XML protocol and send the fetch request to the server. A server can receive the fetch request, process the request, and send a fetch response that contains model data (e.g., model identifier, property objects, property values) for creating a client-side model to the client. The model fetcher 505 can receive the fetch response from the server and store the model identfier in model identifier data 551 in the data store 540 and can create multiple sets of model objects 541,543 using the property objects and property values in the fetch response.

The model fetcher 505 can create a source set of model objects 541 and a working set of model objects 543, and can store the model objects 541,543 in the data store 540. The sets of model objects can contain object reference identifiers and object reference values. The source set 541 is a direct representation of the object definitions contained in the fetch response, and the values of the objects it contains can remain unmodified for the lifetime of the client-side model. The working set 543 is a clone (a copy) of the source set 541 and its objects values can be updated by the client. Subsequently, a model updater 515 can compare the object values in the source set 541 to the object values in the working set 543 to identify any changes that a user has made to the client-side model.

The model fetcher 505 can use the model data in the fetch response to create a client-side object graph 547 for the client-side model and store the object graph 547 in the data store 540. The relationships between the database objects in the client-side model and the relationships between instances of the objects can be illustrated in an object graph 547 for the client-side model. Thus, the model fetcher 505 can create a client-side model representation of the server-side model by creating a source set of model objects 541, a working set of model objects 543, and an object graph 547.

In some cases, a server-side model contains a large number of persistent objects and has a large object graph, and a server may send a fetch response that contains model data for only a partial object graph to the client, thus leaving certain object properties uninitialized (e.g., lazily-loaded entity associations) in a client-side model. The model fetcher 505 can fetch a portion of the server-side model object graph and create a client-side model having an object graph 547 that contains initialized and unitialized branches of the objects, but within the same persistence context.

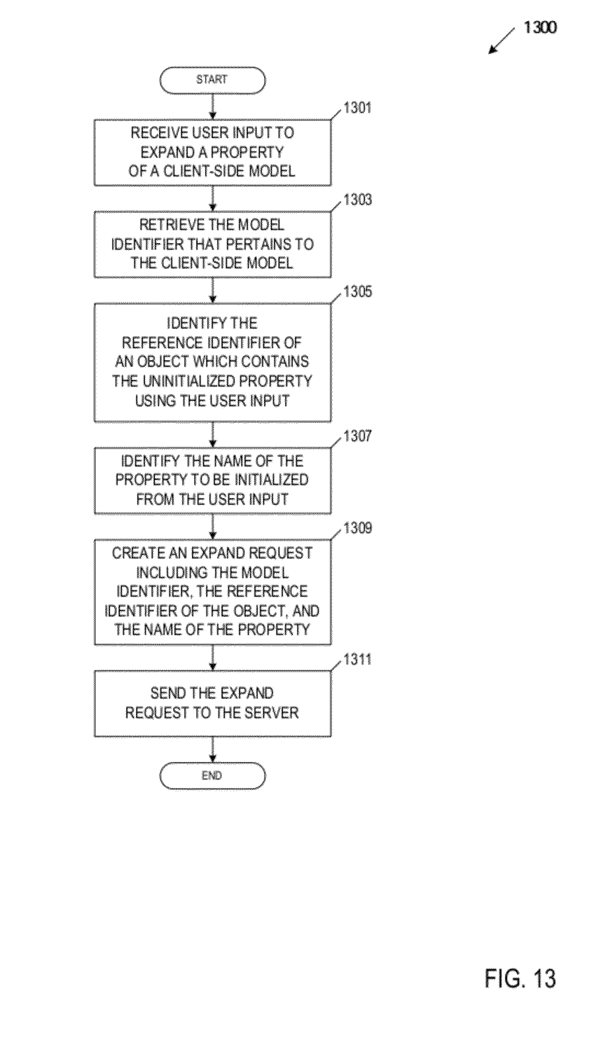

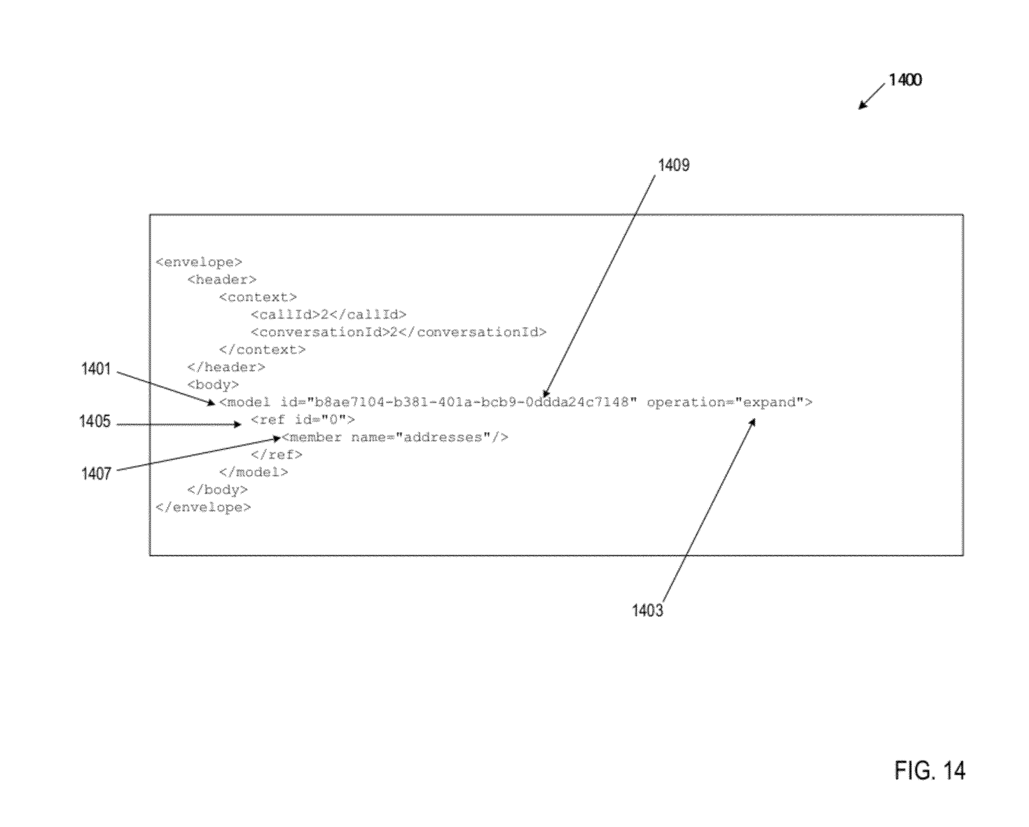

The model expander 510 can expand a client-side model after the initial fetch operation (e.g., first request operation) has completed by dynamically initializing (e.g., assigning values to, loading values for) previously uninitialized property values using one or more additional request operations (e.g., expand request operations) with the server. The model expander 510 can receive user input specifying which uninitialized properties of a server-side model to retrieve from a server. A user can enter and/or select remoting code for specifying the uninitialized properties which are to be loaded to expand the client-side model. The model expander 510 can create an expand request to be sent to the server in an additional request operation with the server based on the user input. The model expander 510 can format the expand request utilizing the XML protocol and send the expand request to the server. An exemplary expand request is described in greater detail below in conjunction with FIG. 14, according to one embodiment of the invention. The server can receive the expand request, process the request, and send an expand response to the client. The model expander 510 can receive the expand response from the server and can expand the client-side model using the model data in the expand response. The model expander 510 can load previously uninitialized object properties (e.g., addresses property object 209 in FIG. 2B) based on the data in the expand response and attach the properties to the client-side object graph 547. One embodiment of a method for expanding a client-side model is described in greater detail below in conjuction with FIG. 13.

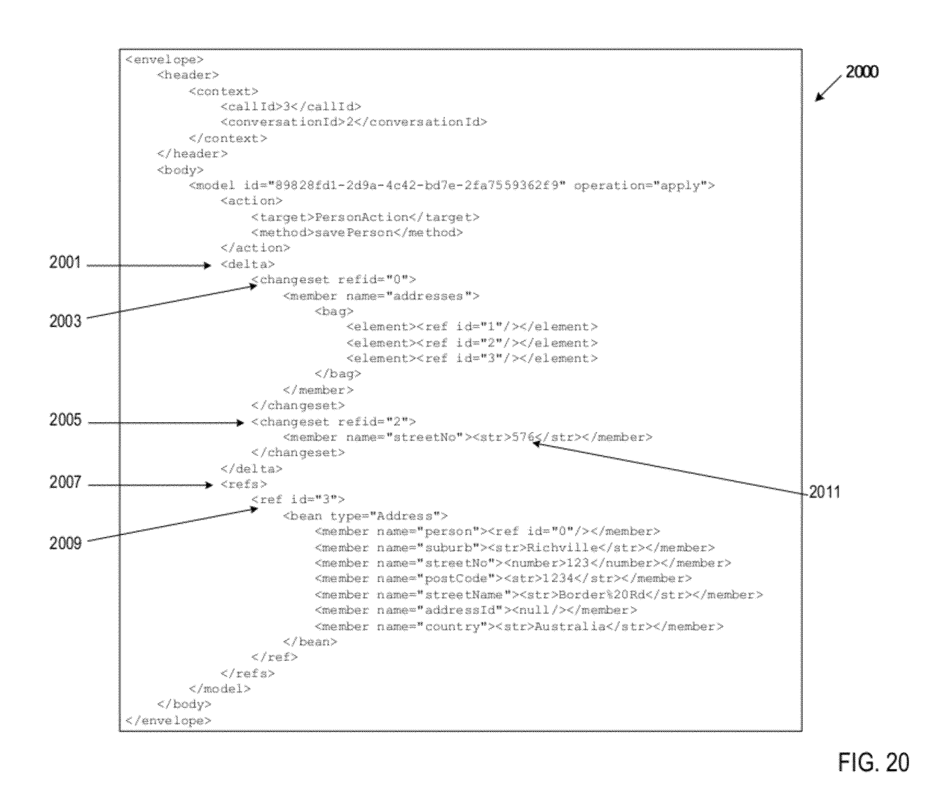

When a user is finished making updates (e.g., changing property values) to a client-side model, the model updater 515 can apply any changes (updates) which a user has made to the client-side model to the server-side model in an update operation with the server within the same persistence context. The model updater 515 can create an object delta 549 that contains a property value change for one or more objects contained in the client-side model. The model updater 515 can create the object delta 549 by comparing the property value of an object in the working set of objects 543 to the original property value for the corresponding object in the source set of objects 541. The model updater 515 can store property change data for the property values which do not match as part of the changed data 553 in the data store 540. The property change data can include, and is not limited to, the object reference, the property name, and the new property value. The model updater 515 can create an update request using the delta 549, for example, formatted utilizing the XML protocol, and can send the update request to the server, which the server can then apply to the objects in the server-side object graph. An exemplary update request is described in greater detail below in conjunction with FIG. 20, according to one embodiment of the invention.

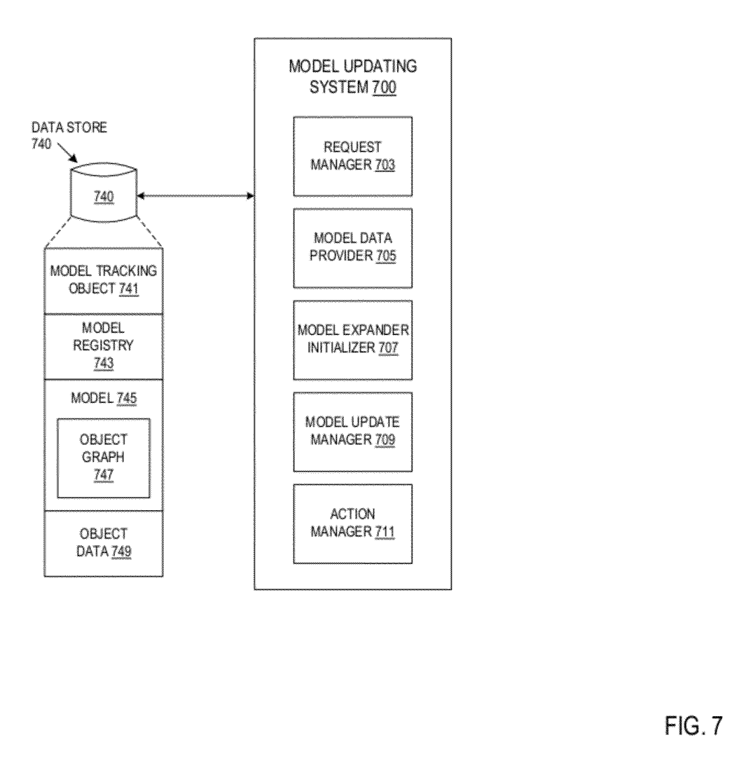

FIG. 7 is a block diagram of one embodiment of a model updating system 700 for enabling incremental changes to expand a client-side model within a same persistence context and applying remote updates to a server-side model using a single update operation within the same persistence context. The model updating system 700 may be the same as the model updating system 150 hosted by a server 115 of FIG. 1. The model updating system 700 can include a request manager 703, a model data provider 705, a model expander initializer 707, a model update manager 709, and an action manager 711.

A server can store information in a database in a data store 740. For example, the server can store customer information in a customer database in the data store 740. The database can be an object database that has a server-side model 745 in which information is represented in the form of objects. The server-side model 745 can include a server-side object graph 747. The data store 740 can store object data 749 pertaining to the objects in the server-side object graph 747. The object data 749 can describe, and is not limited to, for example, model properties, property objects, property values, etc. The object data 749 can include, and is not limited to, object reference identifiers, property names, etc.

A client hosting a model remoting system can request model data from a server and create a client-side object model that is a working representation of a server-side object model for a particular persistence context (e.g., conversation context) based on model data received from the server. For example, a client can create and store a client-side model representing the server-side model of the customer database. A user, such as a web application developer, may wish to change (update) data pertaining to the customer database, and can use the client-side model to implement the changes (updates). For example, a client can edit a customer's address data in the client-side model based on user input and apply the changes (updates) to the server-side model via an update operation, within the same persistence context.

The client can send one or more requests to the server in one or more operations with the server. An ‘operation’ can refer to a client sending a request to a server and receiving a response from a server. The client can send, for example, a fetch request, an expand request, and an update request to the server. The server can include a model updating system 700 to receive requests from the client, provide multiple sets of model data to the client, receive change (update) data from the client, and change (update) the server-side model based on the received data, all within a same persistence context. The request manager 703 can receive a request from a client and can determine the request type from an operation attribute that is included in the request. When the request manager 703 receives a fetch request from a client, the model data provider 705 can prepare model data to send to the client based on the data in the fetch request, and send a fetch response that includes the prepared model data to the client. Examples of model data include, and are not limited to, a unique model identifier, property objects, and property values.

The model data provider 705 can create a new model object 741 to track the state of a server-side model between client requests and can store the new model object 741 in a data store 740 that is coupled to the system 700. The model data provider 705 can assign a unique model identifier to the new model object 741 and can use the model identifier to register the new model object 741 within a model registry 743 stored in the data store 740. The model data provider 705 can detect any action that is specified in the fetch request and the action manager 711 can invoke the specified action. The model data provider 705 can read the model property values for the model properties that are specified in the fetch request from the object data 749 and can construct a fetch response that contains a serialized respresentation of the properties, the property objects, and any other objects that are referenced, either directly or indirectly, by the objects, and the property values. The fetch response can contain initialized properties and uninitialized properties. The model data provider 705 can format the fetch response utilizing the XML protocol and can send the fetch response to the client.

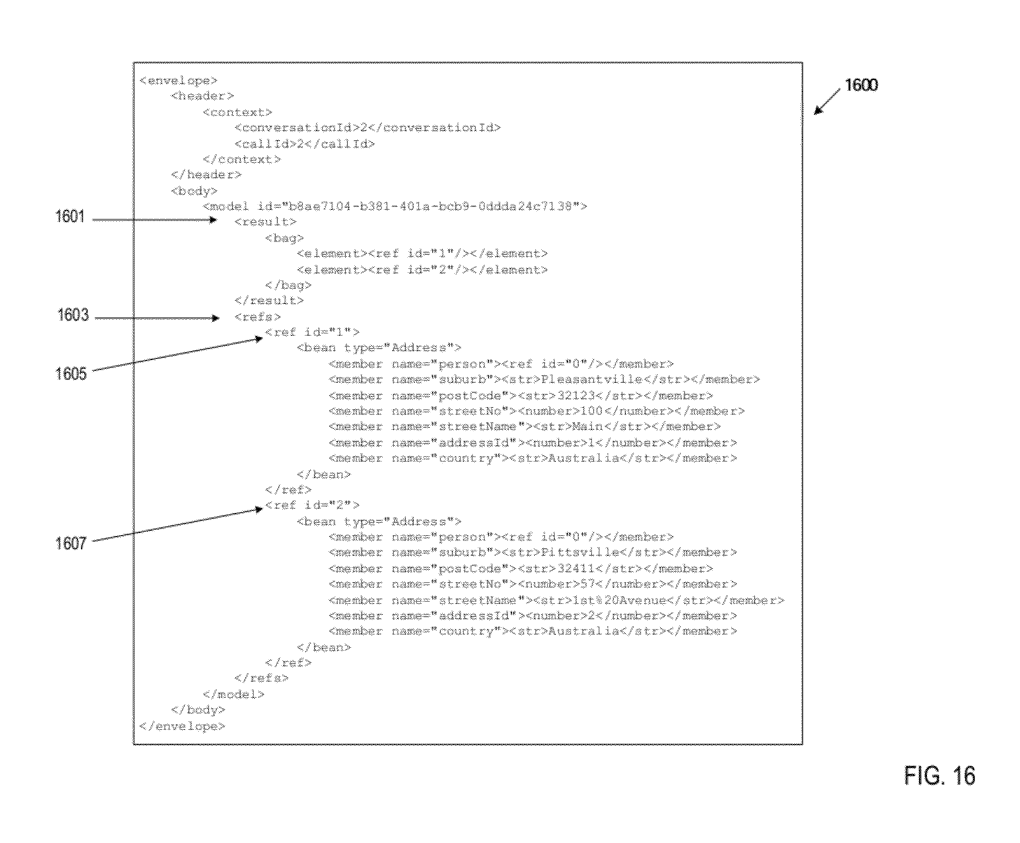

When the request manager 703 receives an expand request from a client, the model expander initializer 707 can use the object data 749 to initialize one or more server-side model properties based on the data in the expand request and send an expand response to the client. The model expander initializer 707 can locate the model object in the model registry 743 using the model identifier that is specified in the expand request. The model expander initializer 707 can read the object reference identifier and the property name that is specified in the expand request and can locate the associated object from the object data 749. The model expander initializer 707 can initialize the server-side model property of the object that is identified by the property name and prepare an expand response that contains the initialized property values. The model expander initializer 707 can format the expand response utilitzing the XML protocol and send the expand response to the client. An exemplary XML expand response, according to one embodiment of the invention, is described in greater detail below in conjunction with FIG. 16.

When the request manager 703 receives an update request from a client, the model update manager 709 can update the server-side model based on the data in the update request. The model update manager 709 can first unmarshall any new object references that are contained in the update request. As is known in the art, in data storage, “unmarshalling” is the process of extracting a data structure from a series of bytes. The model update manager 709 can then examine the update request to identify the elements in the delta that is included in the update request. For each identified element in the delta, the model update manager 709 can locate the local object using the unique reference identifier specified in the update request and then apply the new property (member) values contained in the update request to the local object in the object data 749. Once the model update manager 709 has applied all of the changes as specified in the update request, the action manager 711 can invoke any action that is specified in the update request. For example, the action manager 711 may invoke an action that commits a database transaction if the objects contained in the model are persistent entity objects.

FIG. 8 is a flow diagram of an embodiment of a method 800 of a client expanding a client-side model within a same persistence context and invoking remote updates to a server-side model within the same persistence context. Method 800 can be performed by processing logic that can comprise hardware (e.g., circuitry, dedicated logic, programmable logic, microcode, etc.), software (e.g., instructions run on a processing device), or a combination thereof. In one embodiment, method 800 is performed by the model remoting system 140 hosted by a client 135 of FIG. 1.

In one embodiment, the method 800 starts with the model remoting system sending a fetch request to a server in a first operation to obtain model data of a server-side model for a particular persistence context (e.g., conversation context to edit an existing customer instance in a customer database) at block 801. As noted above, an ‘operation’ can refer to a client sending a request to a server and receiving a response from a server. For example, a server can store a server-side model for a customer database that includes a Person object and an Addresses obejct. The Person object can have model properties, such as Last Name, First Name, and Address. The Addresses object can have its own properties, such as, suburb and post code. In this example, the model remoting system can send a fetch request to the server in a first request operation to obtain model data for the server-side model for a conversation context. The fetch request can include data that identifies the model properties to be fetched. Since the conversation context is to edit an existing customer instance in the customer database, the fetch request can be for fetching only the Person object in the server-side model to create a client-side model.

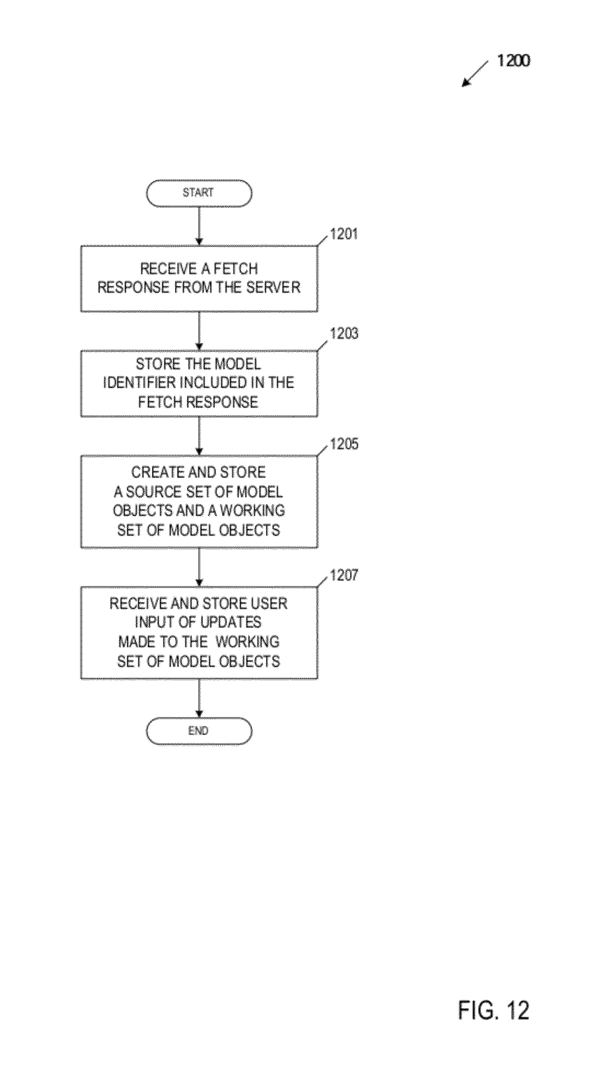

At block 803, the model remoting system receives the model data from the server and creates a working client-side copy of the server-side model based on the received model data at block 805. The client-side model includes a client-side object graph for the client-side model, a source set of model objects, and a working set of model objects. One embodiment of a method for creating the client-side model is described in greater detail below in conjunction with FIG. 12.

At block 807, the model remoting system receives user input of updates made by a user to the client-side model, such as changes made to the property values in the set of working objects in the client-side model. For example, the model remoting system receives user input changing a person's name in a Person record. The model remoting system can receive user input specifying more than one update to the client-side model. Alternatively, the model remoting system may not receive user input at block 807 and the method 800 continues to block 809.

A user may wish to change (e.g., expand) a client-side model in order to work with any uninitialized properties in the client-side model. An expand operation enables a client to make incremental changes to a client-side model, such as loading objects that were initially uninitialized in the client-side model, within a same persistence context. At block 809, when a user wishes to expand the client-side model, the model remoting system sends an expand request to the server in another operation with the server for expanding the client-side model, but for the same persistence context. The model remoting system may have received model data from the server for a partial object graph (block 803). For example, the model remoting system receives model data for the Person object, but not the Addresses object at block 803. The client-side object graph may have a portion that is initialized, leaving a remaining portion (e.g., Addresses object) of the object graph in the client-side model uninitialized in an undefined state. The model remoting system can request model data for the Addresses object from the server to expand the client-side model and allow a user to work with instances for the Addresses object. At block 809, the model remoting system requests additional nodes (e.g., Addresses object) of the server-side object graph from the server to be loaded in the client-side model, yet all within the same persistence context. The model remoting system receives an expand response from the server and uses the additional model data in the expand response to expand the client-side model. For example, the model remoting system can receive the model data in an expand response from a sever and append the address records to the Person object of the client-side model. One embodiment of a method for expanding the client-side model is described in greater detail below in conjunction with FIG. 13.

At block 811, the model remoting system determines whether to update the server-side model with the updates made to the client-side model. When a user is finished making updates (e.g., changing property values) to a client-side model, a user can provide user input indicating the model remoting system to update the server-side model (e.g., detecting a user clicking an indicator in a graphical user interface of a framework tool user interface). If the model remoting system does not receive user input to update the server-side model, the model remoting system returns to receiving user input of updates made to the client-side working model at block 807. Using additional operations, the model remoting system can further expand the client-side model at block 809. If the model remoting system receives user input to update the server-side model (block 811), the model remoting system sends an update request to the server to update the server-side model at block 813. The update request includes data that describes the updates made to the client-side working model. One embodiment of a method for updating the server-side model is described in greater detail below in conjunction with FIG. 18.

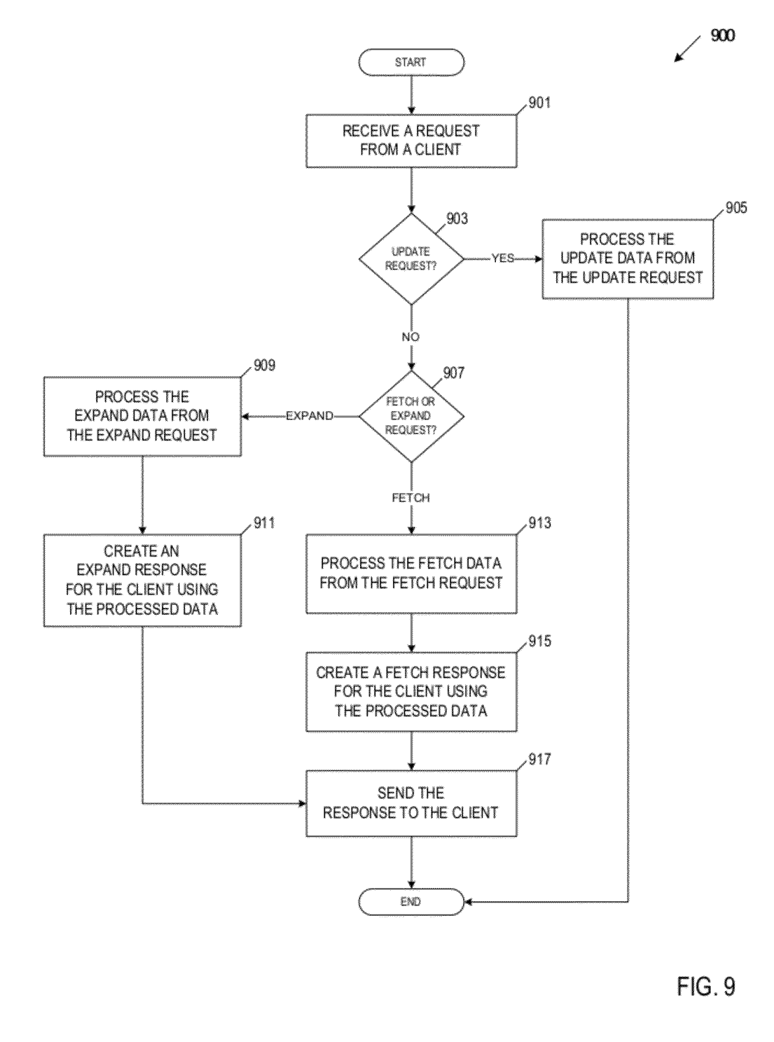

FIG. 9 is a flow diagram of an embodiment of a method 900 for a server servicing client requests to expand a client-side model and to apply remote updates to a server-side model all within a same persistence context. Method 900 can be performed by processing logic that can comprise hardware (e.g., circuitry, dedicated logic, programmable logic, microcode, etc.), software (e.g., instructions run on a processing device), or a combination thereof. In one embodiment, method 900 is performed by the model updating system 150 hosted by a server 115 of FIG. 1. In one embodiment, the method 900 starts with the model updating system receiving a request from a client. At block 903, the model remoting system determines whether the request is an update request to update a server-side model. The model remoting system can examine the data in the request to determine the type of request. If the request is an update request the model remoting system updates a server-side model based on data in the update request at block 905. One embodiment of a method for updating the server-side model is described in greater detail below in conjunction with FIG. 18.

If the request is not an update request the model remoting system determines whether the request is a fetch request to retrieve model data for creating a client-side model or an expand request to expand a client-side model at block 907. If the request is a fetch request, the model remoting system processes the data in the fetch request at block 913. The model remoting system creates a fetch response for the client based on the processed data at block 915, and sends the response to the client at block 917. If the request is expand request (block 907), the model remoting system processes the data in the expand request at block 909. The model remoting system creates an expand response for the client within a same persistence context based on the process data at block 911, and sends the response to the client at block 917. An exemplary expand response, according to one embodiment of the invention, is described in greater detail below in conjunction with FIG. 16.

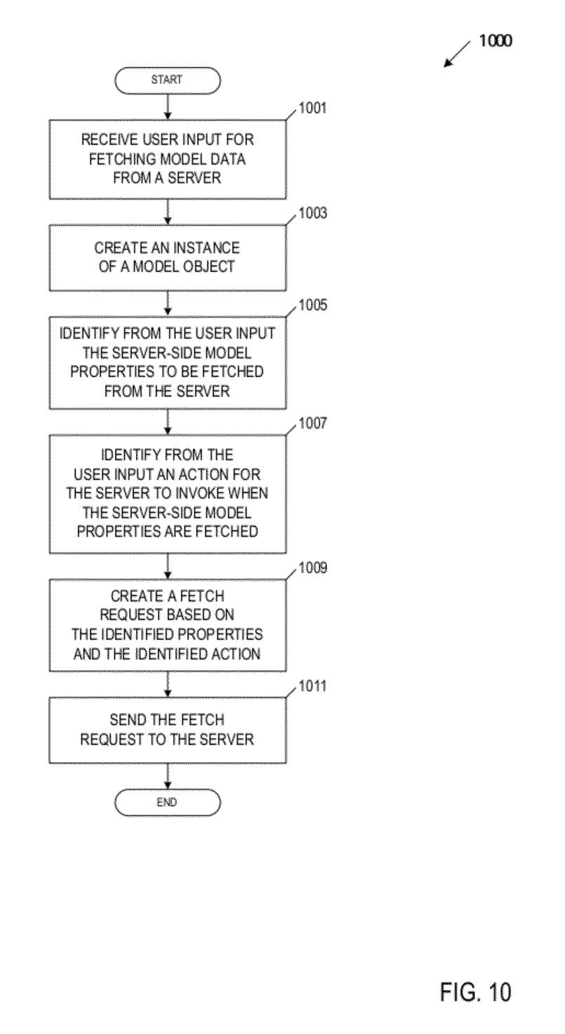

FIG. 10 is a flow diagram of an embodiment of a method 1000 for a client creating a client-side model. Method 1000 can be performed by processing logic that can comprise hardware (e.g., circuitry, dedicated logic, programmable logic, microcode, etc.), software (e.g., instructions run on a processing device), or a combination thereof. In one embodiment, method 1000 is performed by the model remoting system 140 hosted by a client 135 of FIG. 1. In one embodiment, the method 1000 starts with the model remoting system receiving user input to fetch model data from a server for a particular persistence context at block 1001. The user input can include remoting code submitted by a user or remoting code that is stored in a data store that is coupled to the model remoting system and selected by a user. At block 1003, the model remoting system creates an instance of a model object (e.g., a new empty model object) and can store it in a data store that is coupled to the model remoting system for a client-side model copy of a server-side model. This instance can be used to invoke all subsequent operations on the same client-side model.

At block 1005, the model remoting system identifies from the user input the server-side model properties to be fetched from the server. The properties can be used for the empty model object to create a client-side object representation of the objects in the server-side model. For example, the model remoting system can receive user input to fetch a Person property of a server-side model. At block 1007, the model remoting system identifies one or more actions from the user input, if any, for a server to invoke a server-side method when the server-side model properties are fetched from the server. At block 1009, the model remoting system creates a fetch request based on the identified model properties and the identified actions, and sends the fetch request to the server at block 1011. The model remoting system can format the fetch request utilizing the XML protocol.

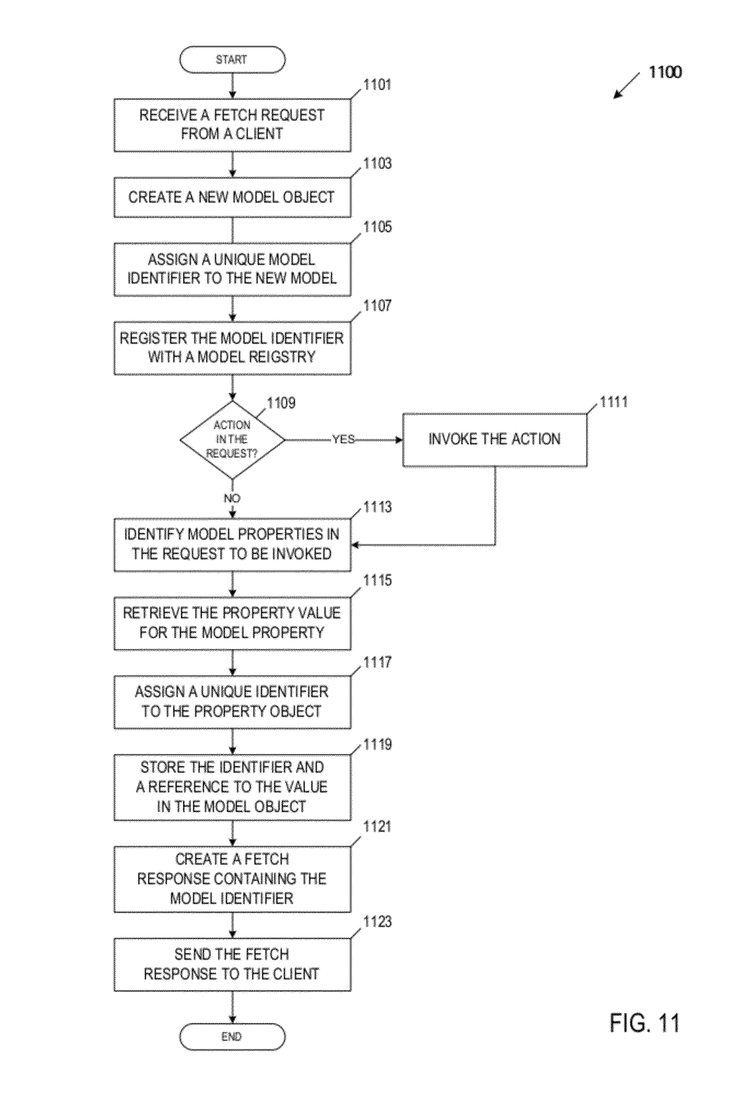

FIG. 11 is a flow diagram of an embodiment of a method 1100 for a server servicing a fetch request from a client for retrieving model data. Method 1100 can be performed by processing logic that can comprise hardware (e.g., circuitry, dedicated logic, programmable logic, microcode, etc.), software (e.g., instructions run on a processing device), or a combination thereof. In one embodiment, method 1100 is performed by the model updating system 150 hosted by a server 115 of FIG. 1. In one embodiment, the method 1100 starts with the model updating system receiving a fetch request from a client for a particular persistence context at block 1101. The fetch request can be in the XML protocol, such as the exemplary fetch request 300 in FIG. 3, according to one embodiment of the invention. At block 1103, the model updating system creates a new model object to track the state of the server-side model between client requests received from the client and assigns a unique model identifier to the new model object at block 1105. At block 1107, the model updating system uses the model identifier to register the new model within a model registry that is stored in a data store which is coupled to the model updating system. The unique model identifier can be used in subsequent requests received from the client to identify to the server which model instance a request pertains to.

At block 1109, the model updating system determines whether the fetch request includes an action to be invoked. The model updating system can examine, for example, an action element (e.g., /envelope/body/model/action) in the fetch request to determine whether any action is to be invoked. If an action is specified in the fetch request, the model updating system invokes the action at block 1111. At block 1113, the model updating system identifies, from the fetch request, one or more server-side model properties to be fetched. For example, the model updating system can examine bean elements in the fetch request and identify properties (e.g., a Person property) that are to be fetched. At block 1115, for each requested model property, the model updating system performs an evaluation to retrieve the one or more property objects for the identified property and the property values for the property objects. The model updating system can “walk” through the server-side object graph by scanning each of the properties of the server-side model to discover other objects. For every property object that is found, the model updating system assigns a unique reference identifier to the model property object at block 1117, and then recursively repeats the scanning process until all of model property objects have been discovered. The unique property object identifiers can be maintained over multiple requests, for the entire lifetime of the model object, and can be used to coordinate subsequent object update requests received from the client.

At block 1119, the model updating system stores the unique identifier for a model property and a reference to the property object for the model property. Once all of the model property values have been evaluated, the model updating system creates a fetch response containing model data for creating the client-side model at block 1121. The model data can include the unique model identifier, the property objects for the requested properties, and the property values. The model updating system can encapsulate the fetch response within an XML packet. At block 1123, the model updating system sends the fetch response to the client.

FIG. 12 is a flow diagram of an embodiment of a method 1200 for creating a client-side model for a particular persistence context . Method 1200 can be performed by processing logic that can comprise hardware (e.g., circuitry, dedicated logic, programmable logic, microcode, etc.), software (e.g., instructions run on a processing device), or a combination thereof. In one embodiment, method 1200 is performed by the model remoting system 140 hosted by a client 135 of FIG. 1.

A server may have received a fetch request from the client, processed the fetch request, and send a fetch response to the client. In one embodiment, the method 1200 starts with the model remoting system receiving the fetch response from the server at block 1201. The fetch response can include object reference identifiers and corresponding object reference values for the property objects. The fetch response can be an XML response. For example, a XML fetch response includes object reference identifiers and reference values in a references element (e.g., /envelope/body/model/refs).

At block 1203, the model remoting system stores a unique model identifier that is included in the fetch response in a data store that is coupled to the model remoting system. The model remoting system can use the unique model identifier in subsequent requests sent to the server to identify to the server which model instance a request pertains to. At block 1205, the model remoting system reads the object reference values in the fetch response and creates a source set of model objects and a working set of model objects using the values. The source set is a direct representation of the object definitions contained in the fetch response, and the objects contained in the source set remain unmodified for the lifetime of the client-side model. The working set is a clone (a copy) of the source set and a user may update the objects that are contained in the working set. A source set of the model objects and a working set of the model objects can be an array object and its elements can correspond to the reference identifiers that are specified in the fetch response received from the server. For example, an object specified with <ref id=“0”> (e.g., object 405 in fetch response 400 in FIG. 4), can be stored in element 0 of the array. An object specified with <ref id=“1”> can be stored in element 1, etc. The source set of model objects and the working set of model objects can be stored in a data store that is coupled to the model remoting system.

At block 1207, the model remoting system receives and stores user input of updates made to the working set of the model objects. For example, a user can change the dateOfBirth property value in the working model for the object having <ref id=“0”>. In another example, a user can add and delete objects. The updates can be stored in the working set of model objects in the data store.

FIG. 13 is a flow diagram of an embodiment of a method 1300 for a client sending a request to a server for additional model data for expanding a client-side model for a same persistence context. Method 1300 can be performed by processing logic that can comprise hardware (e.g., circuitry, dedicated logic, programmable logic, microcode, etc.), software (e.g., instructions run on a processing device), or a combination thereof. In one embodiment, method 1300 is performed by the model remoting system 140 hosted by a client 135 of FIG. 1.

A server may initially return a partial object graph to a client for a particular persistence context, and thus some properties in an object graph for a client-side model may not be initialized and are in an undefined state (e.g., the addresses property 413 in FIG. 4). A user may wish to dynamically expand the client-side object graph by loading previously uninitialized object properties and attach them to the existing client-side model object graph within the same persistence context. An expand operation enables a client to make incremental changes (e.g., expanding) to a client-side model, such as loading objects that were initially uninitialized in the client-side model, within a same persistence context. In one embodiment, the method 1300 starts with the model remoting system receiving user input of one or more properties to be initialized for expanding the client-side model at block 1301. The model remoting system can receive user input in the form of remoting code that specifies the properties to be initialized by the server. For example, user input may be:
model.expand(model.getValue(“person”), “addresses”);

In this example, the model remoting system receives user input to have the addresses property of the server-side model's Person object to be initialized. At block 1303, the model remoting system uses the user input to retrieve the model identifier of the server-side model that pertains to the client-side model to be expanded. The model remoting system can search model identifier data that is stored in a data store that is coupled to the model remoting system.

At block 1305, the model remoting system uses the user input to identify the reference identifier of the object (e.g., Person object) which contains the uninitialized property. The model remoting system can search the array of identifiers in the source set or working set of model objects for the reference identifier for the object in the user input. For example, the model remoting system can search the array for the reference identifier of the Person object, which is the object that contains the addresses property. At block 1307, the model remoting system identifies the name of the property to be initialized from the user input.

At block 1309, the model remoting system creates an expand request including the model identifier, the reference identifier of the object that contains the property to be initialized, and the name of the property. The expand request can be formatted utilizing the XML protocol. For example, the model remoting system can encapsulate the expand request within an XML packet. At block 1311, the model remoting system can send the expand request to the server.

FIG. 14 is an exemplary expand request 1400 in the XML protocol generated by a client and sent to a server, according to one embodiment of the invention. A client can send an expand request to the server that contains a model identifier and a reference identifier of one or more objects which contain an uninitialized property, which a user wishes to initialize. The expand request can also include the names of the one or more properties to be initialized. The expand request 1400 is an example of a XML expand request packet. In this example, the expand request 1400 refers to a Person object that was previously fetched. A model element 1401 includes an model identifier 1409 that specifies which model the expand operation is to be invoked on, and its operation attribute 1403 that identifies the request as an expand operation. A reference element 1405 contains the reference identifier for the object that contains the uninitialized property (e.g., the Person object). A member element 1407 contains the name of the object's property that is to be initialized (e.g., the addresses property).

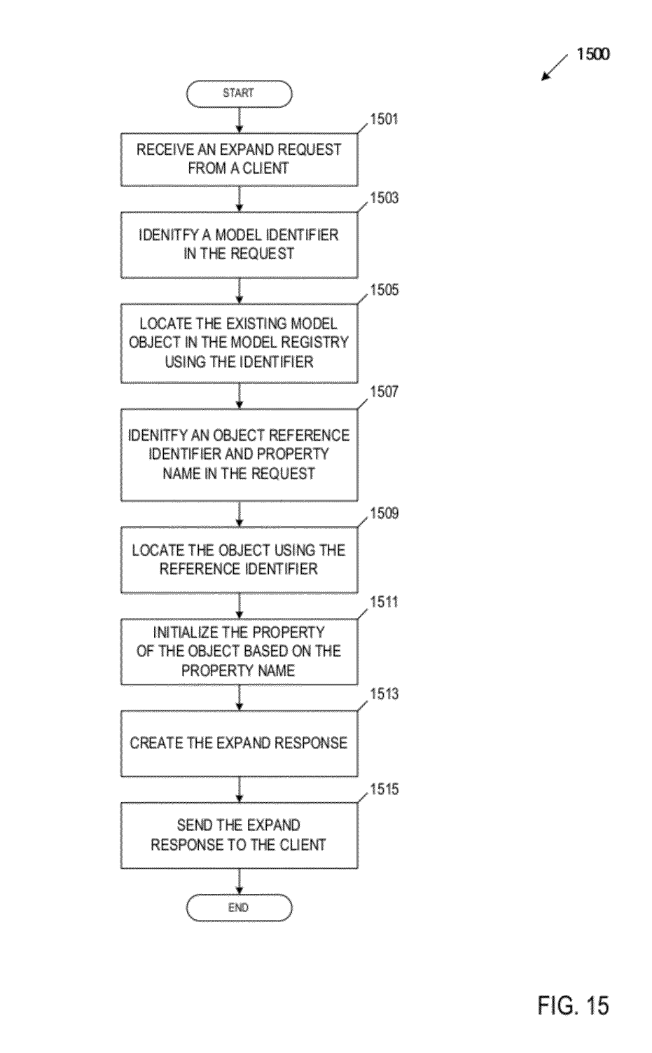

FIG. 15 is a flow diagram of an embodiment of a method 1500 for a server servicing an expand request received from a client for expanding a client-side model within a same persistence context. Method 1500 can be performed by processing logic that can comprise hardware (e.g., circuitry, dedicated logic, programmable logic, microcode, etc.), software (e.g., instructions run on a processing device), or a combination thereof. In one embodiment, method 1500 is performed by the model updating system 150 hosted by a server 115 of FIG. 1.

In one embodiment, the method 1500 starts with the model updating system receiving an expand request from a client. The expand request may be in the XML format (e.g., expand request 1400 in FIG. 14). For example, the model updating system receives an XML expand request that is requesting model data to expand an addresses property of an Person object. At block 1503, the model updating system identifies a model identifier in the expand request and locates the existing model object in a model registry using the model identifier at block 1505. For example, the model updating system can identify the model identifier “b8ae7104-b381-401a-bcb9-0ddda24c7138” in a model element in an expand request and locates the existing model object in the model registry that corresponds to the model identifier.

At block 1507, the model updating system reads the object reference identifier and the property name that is specified in the expand request and locates the associated object using the reference identifier at block 1509. For example, the model updating system reads the object reference identifier <ref id=“0”> and the property (member) name member name=“addresses” in the expand request and locates the associated object that contains the uninitialized property (e.g., Person object).

At block 1511, the model updating system initializes the property of the object that is identified by the property name. For example, the model updating system initializes the addresses property. When initializing the property, the model updating system can encounter new object references. For a new object, the model updating system assigns a unique object identifier and adds it to the model's existing registry of objects.

At block 1513, the model updating system creates an expand response that contains the initialized property and the property value and sends the expand response to the client at block 1515. The model updating system can format the expand response utilizing the XML protocol. For example, the model updating system can encapsulate the expand response within an XML packet. The expand response can include property data for the initialied property (e.g., addresses property for the Person object). The property data can include data, for example, for an object having <ref id=“1”> and an object having <ref id=“2”>, which is described in an exemplary expand response, according to one embodiment of the invention, in conjunction with FIG. 16 below.

FIG. 16 is an exemplary expand response 1600 in the XML protocol created by a server and sent to a client, according to one embodiment of the invention. The expand response 1600 includes the initialized properties and their property values. The result element 1601 indicates to a client the property values to attach to the client-side model object graph. For example, the server returned new object references that have the unique identifiers <ref id=“1”> 1605 and <ref id=“2”> 1607. A references element 1603 indicates to a client which objects to create. A client can append these new object references 1605,1607 to its existing object references (e.g., working set of model objects), which already contains a Person object with <ref id =“0”>.

FIG. 17 is a flow diagram of an embodiment of a method 1700 for a client expanding a client-side model within a same persistence context based on an expand response received from a server. Method 1700 can be performed by processing logic that can comprise hardware (e.g., circuitry, dedicated logic, programmable logic, microcode, etc.), software (e.g., instructions run on a processing device), or a combination thereof. In one embodiment, method 1700 is performed by the model remoting system 140 hosted by a client 135 of FIG. 1.

A server may have received an expand request from the client, processed the expand request, and sent an expand response to the client. In one embodiment, the method 1700 starts with the model remoting system receiving the expand response from the server at block 1701. The expand response may contain references to either existing objects in the client-side object graph or to new objects. At block 1703, the model remoting system first unmarshalls the elements contained in a references element (e.g., /envelope/body/model/refs) in the expand response and creates the objects to represent the elements. At block 1705, the model remoting system unmarshalls results that are contained in a results element (e.g. /envelope/body/model/result) in the expand response to produce the property values to attach to the object graph.

At block 1707, once the results are unmarshalled, the resulting one or more property values are assigned (attached) to one or more previously uninitialized model properties for which the expand operation was requested, after which the values can be available to a user for use. For example, the model remoting system assigns the property data for an object having <ref id=“1”> and for an object having <ref id=“2”> to the addresses property to initialize the addresses property. The addresses property is no longer in an undefined state and the addresses property and the property values for the properties for the object having <ref id=“1”> and for the object having <ref id=“2”> are available to a user to modify. For instance, a user may add a new object having <ref id=“3”> to the addresses property. In another example, a user may change the property value for the streetNo property for the object having <ref id=“2”> from “57” (1715) to “576”.

FIG. 18 is a flow diagram of an embodiment of a method 1800 of a client invoking updates to a server-side model within a same persistence context. Method 1800 can be performed by processing logic that can comprise hardware (e.g., circuitry, dedicated logic, programmable logic, microcode, etc.), software (e.g., instructions run on a processing device), or a combination thereof. In one embodiment, method 1800 is performed by the model remoting system 140 hosted by a client 135 of FIG. 1.

The model remoting system can receive user input of updates made by a user to the client-side model, such as changes made to the property values in the set of working objects in the client-side model. For example, the model remoting system receives user input changing a person's name in a Person record. The model remoting system can receive user input for more than one update to the client-side model. A user may wish to apply the changes made to a client-side model to a server-side model, for example, when a user is finished updating the property values in a client-side model, and the client can apply the changes (updates) to the server-side model within a same persistence context.

In one embodiment, the method 1800 starts with the model remoting system receiving user input that indicates a user wishes to apply changes made to the set of working objects in the client-side model to the server-side model at block 1801. The model remoting system can receive user input in the form, for example, of detecting a user clicking an indicator in a graphical user interface of a framework tool user interface, which can trigger the model remoting system to create an object delta. In another example, the model remoting system can receive user input in the form of remoting code that instructs the model remoting system to create an object delta. An object delta contains a property value change for one or more objects contained in the updated client-side model. The user input can specify an action to be invoked by the server. The model remoting system can specify an action in an action element (e.g., /envelope/body/model/action) in the update request.

At block 1803, the model remoting system identifies a model object for the client-side model (e.g., Person object). At block 1805, the model remoting system determines a property value for a property for the model object, such a value for an addresses property, in the working copy of the model objects. At block 1807, the model remoting system determines the original property value for the property in the source copy of the model objects and compares the values to determine whether the values match at block 1809. If the property values do not match (block 1809), the model remoting system stores a property change for the property at block 1811. The property change can be stored in a data store that is coupled to the model remoting system. The property change can include the object reference, the property name, and the new property value (the value in the working copy of the object).

If the property values match (block 1809), the model remoting system determines whether there is another property for the object at block 1813. For example, the Person object can contain a dateOfBirth property, lastName property, personld property, addresses property, and a firstName property. Properties of an object can also have properties. For example, the addresses property of the Person object can have a person property, a suburb property, a postCode property, a streetNo property, a streetName property, an addressId property, and a country property. For collection properties, such as arrays, lists or maps, the model remoting system can recursively scan for changes for each object contained in the collection, until every object that is referenced either directly or indirectly has been scanned. The model remoting system can examine a list of object references that is stored in a data store that is coupled to the system to track which objects have already been scanned to prevent circular recursion of the scanning process. The model remoting system can update the list of object references as objects are scanned.

If there is another property for the object (block 1813), the model remoting system returns to block 1805 to determine the property value in the working copy of the model objects and to compare it to the original property value. If there is not another property for the object (block 1813), the model remoting system determines whether the client-side model has another object. For example, the model may have objects in addition to the Person object. If model has another object, the model remoting system returns to block 1805 to determine the property value in the working copy of the model objects and to compare it to the original property value.

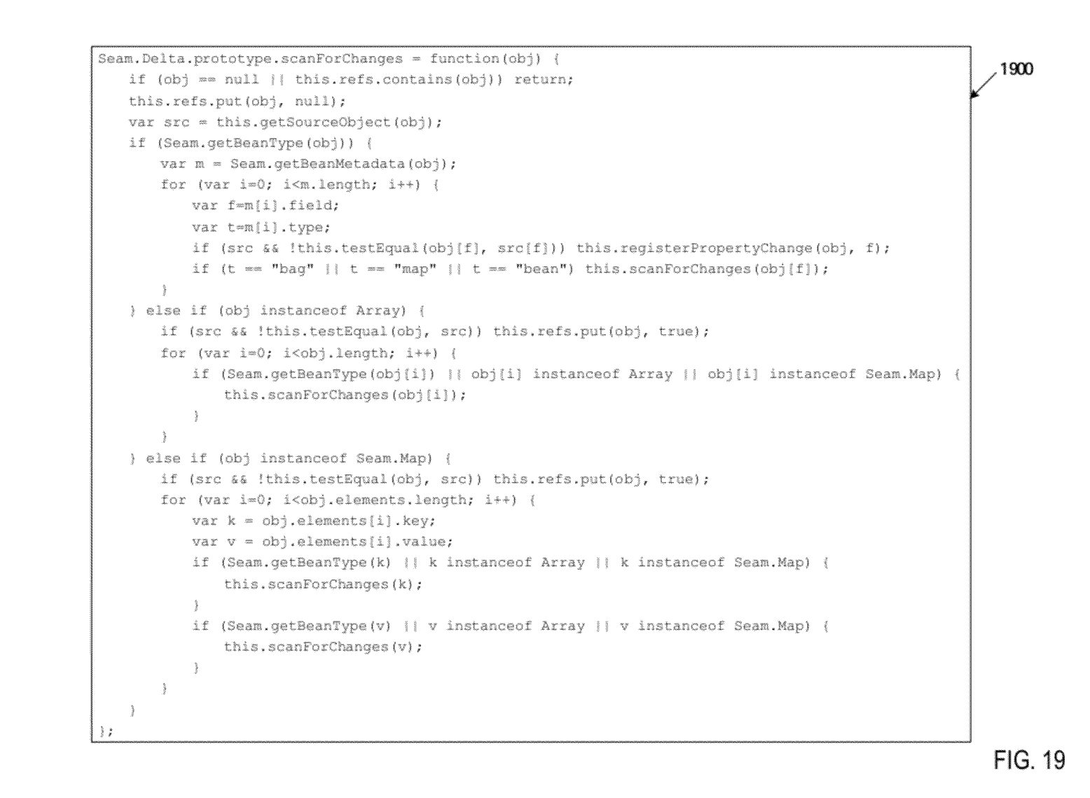

If the model does not have another object (block 1815), the model remoting system creates an object delta (delta) using the registered changes at block 1817. Exemplary code for implementing an algorithm for creating an object delta, according to one embodiment of the invention, is illustrated in FIG. 19. Returning to FIG. 18, and block 1819, the model remoting system creates an update request including the object delta and sends the update request to the server at block 1821. The update request can include an action to be invoked by the server. The update request can be formatted utilizing the XML protocol. For example, the model remoting system can encapsulate the update request within an XML packet. The server can receive the update request and apply the changes (updates) specified in the update request to the corresponding server-side objects. Unlike traditional solutions, a user is allowed to make changes to the server-side object model within the same persistence context via a single update operation, rather than applying all of the changes to the server-side model in multiple discrete operations.

FIG. 20 is an exemplary update request 2000 in the XML protocol sent by a client to a server, according to one embodiment of the invention. After calculating an object delta for an update request, the client creates an XML representation of the delta and sends it to the server. The delta contains a property value change for one or more objects that are contained in the client-side model. Each property value change is represented by a changeset 2003,2005 in a delta element 2001 (e.g., /envelope/body/model/delta) of the update request packet. A changeset can include the object's unique identifier (e.g., refid=“0” and refid=“2”), the name of the property for which the value changed (the member name, such as addresses and streetNo), and the new property value.

For example, the streetNo property for <ref id=“2”> has a new property value of “576” 2011 instead of “57”. In addition, the addresses property has three objects (<ref id=“1”>, <ref id=“2”>, <ref id=“3”>) instead of two objects. If any property value contains a reference to a new object that was not previously part of the client-side model, such as <ref id=“3”> for the addresses property, then the object definition is marshalled and sent as part of the update request in a references element 2007 (e.g., /envelope/body/model/refs). For example, the object definition 2009 for <ref id=“3”> is included in the update response in the /envelope/body/model/refs 2007 element. In the case of collection values, a change to any element contained within the collection can cause the entire collection to be marshalled in the update request.

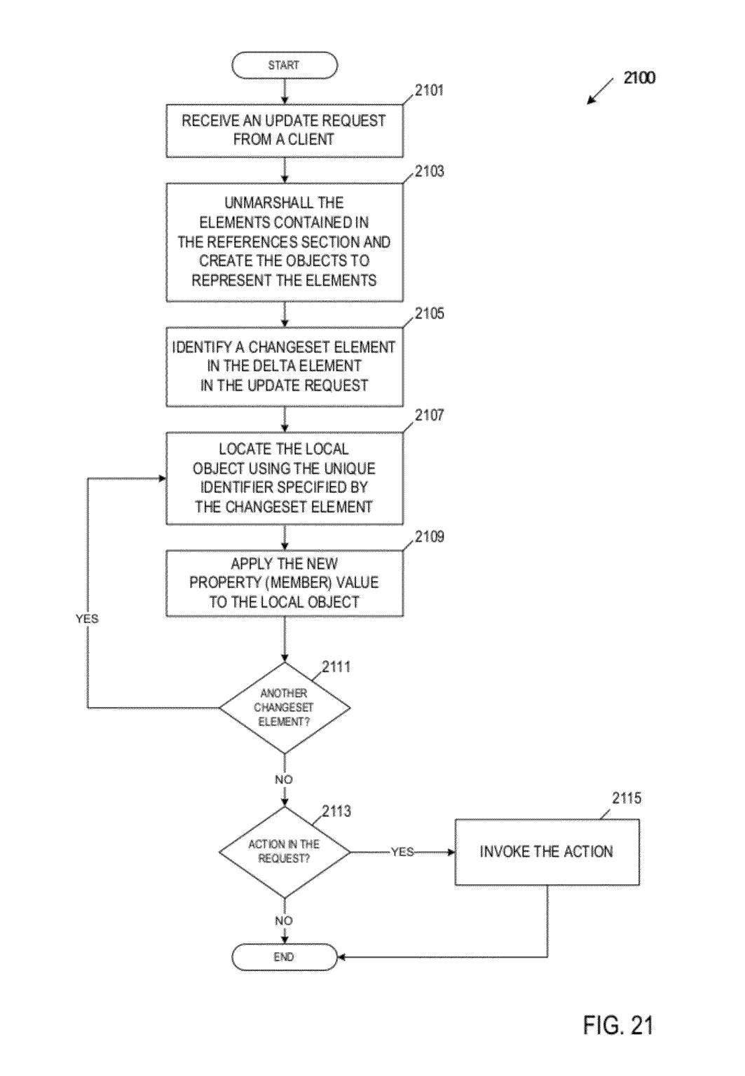

FIG. 21 is a flow diagram of an embodiment of a method 2100 for a server servicing an update request from a client for updating a server-side model within a same persistence context. Method 2100 can be performed by processing logic that can comprise hardware (e.g., circuitry, dedicated logic, programmable logic, microcode, etc.), software (e.g., instructions run on a processing device), or a combination thereof. In one embodiment, method 2100 is performed by the model updating system 150 hosted by a server 115 of FIG. 1.

In one embodiment, the method 2100 starts with the model updating system receiving an update request from a client. The update request can include an object delta containing a property value change for one or more objects that are contained in the client-side model. The update request can be an XML update request. At block 2103, the model updating system unmarshalls any new object references (e.g., <ref id=“3”> 2009 in FIG. 20) contained within a references element (e.g., /envelope/body/model/refs) in the update request. At block 2105, the model updating system scans the update request for changeset elements within a delta element in the update request (e.g., /envelope/body/model/delta). For each changeset element found, the model updating system locates the local object using the unique identifier specified by the changeset at block 2107. At block 2109, the model updating system applies the new property (member) value contained in the changeset to the local object.

At block 2111, the model updating system determines whether there is another changeset element to apply. If there is another changeset element, the model updating system returns to block 2107 to locate the local object using the unique identifier specified by the changeset. If there is not another changeset element (block 2111), the model updating system determines whether there is an action to execute at block 2113. The model updating system can examine an action element (e.g., /envelope/body/model/action) in the update request, to determine whether there is an action to invoke. If there is an action, the model updating system invokes the action at block 2115. This action may, for example, commit a database transaction if the objects contained in the model are persistent entity objects.

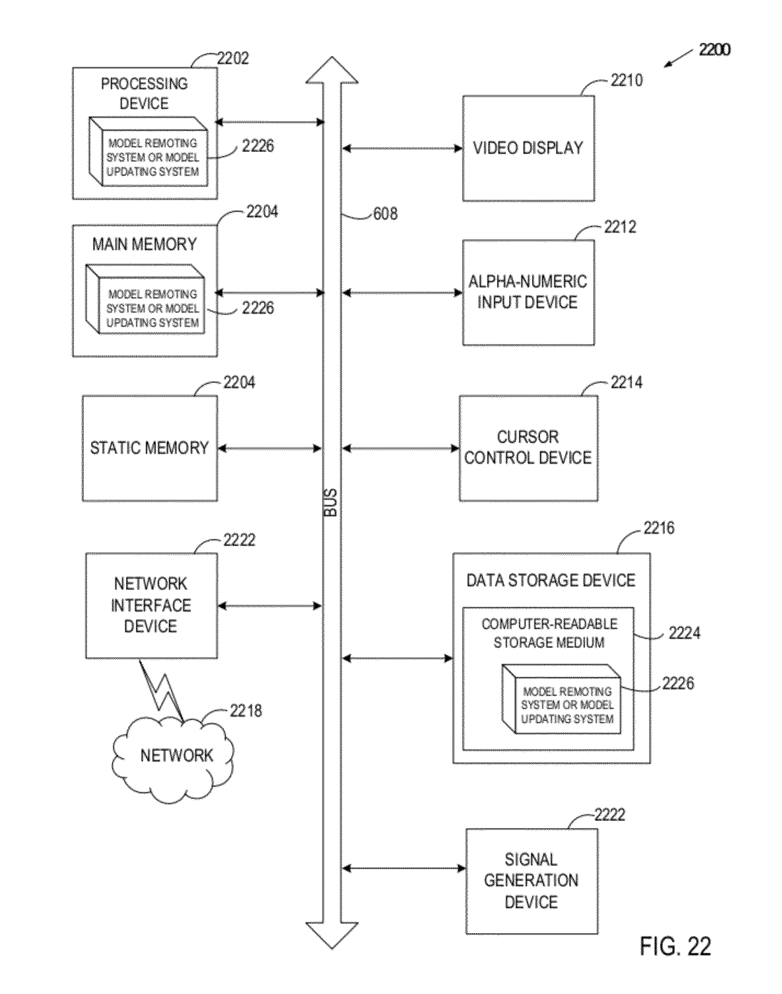

FIG. 22 is a diagram of one embodiment of a computer system for enabling a client to expand a client-side model within a same persistence context and to remotely apply updates to a server-side model within the same persistence context. Within the computer system 2200 is a set of instructions for causing the machine to perform any one or more of the methodologies discussed herein. In alternative embodiments, the machine may be connected (e.g., networked) to other machines in a LAN, an intranet, an extranet, or the Internet. The machine can operate in the capacity of a server or a client machine (e.g., a client computer executing the browser and the server computer executing the automated task delegation and project management) in a client-server network environment, or as a peer machine in a peer-to-peer (or distributed) network environment. The machine may be a personal computer (PC), a tablet PC, a console device or set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 2200 includes a processing device 2202, a main memory 2204 (e.g., read-only memory (ROM), flash memory, dynamic random access memory (DRAM) such as synchronous DRAM (SDRAM) or DRAM (RDRAM), etc.), a static memory 2206 (e.g., flash memory, static random access memory (SRAM), etc.), and a secondary memory 2216 (e.g., a data storage device in the form of a drive unit, which may include fixed or removable computer-readable storage medium), which communicate with each other via a bus 2208.

Processing device 2202 represents one or more general-purpose processing devices such as a microprocessor, central processing unit, or the like. More particularly, the processing device 2202 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 2202 may also be one or more special-purpose processing devices such as an application specific integrated circuit (ASIC), a field programmable gate array (FPGA), a digital signal processor (DSP), network processor, or the like. Processing device 2202 is configured to execute the model remoting system or model updating system 2226 for performing the operations and steps discussed herein.

The computer system 2200 may further include a network interface device 2222. The computer system 2200 also may include a video display unit 2210 (e.g., a liquid crystal display (LCD) or a cathode ray tube (CRT)) connected to the computer system through a graphics port and graphics chipset, an alphanumeric input device 2212 (e.g., a keyboard), a cursor control device 2214 (e.g., a mouse), and a signal generation device 2220 (e.g., a speaker).

The secondary memory 2216 may include a machine-readable storage medium (or more specifically a computer-readable storage medium) 2224 on which is stored one or more sets of instructions (e.g., the model remoting system or model updating system 2226) embodying any one or more of the methodologies or functions described herein. The model remoting system or model updating system 2226 may also reside, completely or at least partially, within the main memory 2204 and/or within the processing device 2202 during execution thereof by the computer system 2200, the main memory 2204 and the processing device 2202 also constituting machine-readable storage media. The model remoting system or model updating system 2226 may further be transmitted or received over a network 2218 via the network interface device 2222.

The computer-readable storage medium 2224 may also be used to store the model remoting system or model updating system 2226 persistently. While the computer-readable storage medium 2224 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media.

The model remoting system or model updating system 2226, components and other features described herein (for example in relation to FIG. 1) can be implemented as discrete hardware components or integrated in the functionality of hardware components such as ASICS, FPGAs, DSPs or similar devices. In addition, the model remoting system or model updating system 2226 can be implemented as firmware or functional circuitry within hardware devices. Further, the model remoting system or model updating system 2226 can be implemented in any combination hardware devices and software components.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed description which follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “creating,” “expanding,” “updating,” “sending,” “receiving,” “assigning,” “identifying, “retrieving,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the invention also relate to an apparatus for performing the operations herein. This apparatus can be specially constructed for the required purposes, or it can comprise a general purpose computer system specifically programmed by a computer program stored in the computer system. Such a computer program can be stored in a computer-readable storage medium, such as, but not limited to, any type of disk including optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems can be used with programs in accordance with the teachings herein, or it may prove convenient to construct a more specialized apparatus to perform the method steps. The structure for a variety of these systems will appear from the description below. In addition, embodiments of the present invention are not described with reference to any particular programming language. It will be appreciated that a variety of programming languages can be used to implement the teachings of embodiments of the invention as described herein.

A computer-readable storage medium can include any mechanism for storing information in a form readable by a machine (e.g., a computer), but is not limited to, optical disks, Compact Disc, Read-Only Memory (CD-ROMs), and magneto-optical disks, Read-Only Memory (ROMs), Random Access Memory (RAM), Erasable Programmable Read-Only memory (EPROM), Electrically Erasable Programmable Read-Only Memory (EEPROM), magnetic or optical cards, flash memory, or the like.

Thus, a method and apparatus for enabling a client to remotely apply incremental changes to a server-side managed persistence context. It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method, implemented by a client computing system programmed to perform the following, comprising:
creating, by the client computing system, a client model for a persistence context based on first model data that is received from a server in a first operation between the client and the server, the client model being a representation of a model that resides on the server and comprising an initialized model property and an uninitialized model property; and
expanding, by the client computing system, the client model by assigning a value to the uninitialized model property based on at least second model data that is received from the server in at least a second operation between the client and the server within the same persistence context.

2. The method of claim 1, further comprising:
updating the client model within the same persistence context; and
sending an update request to the server to implement the update on the server model within the same persistence context.

3. The method of claim 1, wherein sending the update request to the server comprises:
creating an object delta comprising a property value change for one or more objects contained in the client model; and
creating the update request, the update request including the object delta.

4. The method of claim 1, wherein creating the client model comprises:
creating an instance of a model object;
sending a first request for the first model data to the server in the first operation;
receiving the first model data from the server; and
creating a working set of model objects and a source set of model objects on the client based on the first model data.

5. The method of claim 4, wherein expanding the client model comprises:
sending at least a second request for the second model data for the server model to the server in the at least second operation, the second request comprising a reference identifier of an object that contains the uninitialized property and the name of the uninitialized property to be initialized;
receiving the second model data from the server, the second model data comprising a property value for the uninitialized property to be initialized; and
assigning the property value to the uninitialized model property within the same persistence context for a user to use the property.

6. A method, implemented by a server computing system programmed to perform the following, comprising:
sending, by the server computing system, first model data for a persistent context to a client in response to receiving a first request from the client in a first operation between the client and the server, the first model data comprising one or more model property objects and one or more property values to create a client model, the client model being a representation of a server model for the persistence context comprising an initialized model property and an uninitialized model property; and
sending, by the server computing system, second model data to the client in response to receiving at least a second request from the client in at least a second operation between the client and the server within the same persistence context, the second model data comprising a property value for the uninitialized property for the client to expand the client model.

7. The method of claim 6, further comprising:
updating the server model within the same persistence context in response to receiving an update request from the client, the update request including update data for an update made to the client model.

8. The method of claim 6, wherein sending the first model data comprises:
assigning a model identifier to a new model object;
identifying from the first request a model property to be fetched;
identifying a model property object for the model property; and
retrieving a property value for the model property object.

9. A system comprising:
a persistent storage unit to store a client model representation of a server model for a persistence context and comprising an initialized model property and an uninitialized model property; and
a processor coupled to the persistent storage unit to create the client model for the persistence context based on first model data that is received from a server in a first operation with the server, and to expand the client model by assigning a value to the uninitialized model property based on at least second model data that is received from the server in at least a second operation between the client and the server within the same persistence context

10. The system of claim 9, further comprising the processor:
to update the client model within the same persistence context; and
to send an update request to the server to implement the update on the server model within the same persistence context.

11. A system comprising:
a persistent storage unit to store first model data for a persistence context comprising one or more model property objects and one or more property values to create a client model representation of a server model for the persistence context, the client model comprising an initialized model property and an uninitialized model property, and second model data comprising a property value for the uninitialized property for the client to expand the client model within the same persistence context; and
a processor coupled to the persistent storage unit to send the first model data to a client in response to receiving a first request from the client in a first operation with the client, and to send second model data to the client in response to receiving at least a second request from the client in at least a second operation with the client within the same persistence context.

12. The system of claim 11, further comprising the processor:
to update the server model within the same persistence context in response to receiving an update request from the client, the update request including update data for an update made to the client model.

13. A computer-readable storage medium including instructions that, when executed by a computer system, cause the computer system to perform a set of operations comprising:
creating a client model for a persistence context based on first model data that is received from a server in a first operation between the client and the server, the client model being a representation of a model that resides on the server and comprising an initialized model property and an uninitialized model property; and
expanding the client model by assigning a value to the uninitialized model property based on at least second model data that is received from the server in at least a second operation between the client and the server within the same persistence context.

14. The computer-readable storage medium of claim 13, further comprising:
updating the client model within the same persistence context; and
sending an update request to the server to implement the update on the server model within the same persistence context.

15. The computer-readable storage medium of claim 13, wherein sending the update request to the server comprises:
creating an object delta comprising a property value change for one or more objects contained in the client model; and
creating the update request, the update request including the object delta.

16. The computer-readable storage medium of claim 13, wherein creating the client model comprises:
creating an instance of a model object;
sending a first request for the first model data to the server in the first operation;
receiving the first model data from the server; and
creating a working set of model objects and a source set of model objects on the client based on the first model data.

17. The computer-readable storage medium of claim 16, wherein expanding the client model comprises:
sending at least a second request for the second model data for the server model to the server in the at least second operation, the second request comprising a reference identifier of an object that contains the uninitialized property and the name of the uninitialized property to be initialized;
receiving the second model data from the server, the second model data comprising a property value for the uninitialized property to be initialized; and
assigning the property value to the uninitialized model property within the same persistence context for a user to use the property.

18. A computer-readable storage medium including instructions that, when executed by a computer system, cause the computer system to perform a set of operations comprising:
sending first model data for a persistence context to a client in response to receiving a first request from the client in a first operation between the client and the server, the first model data comprising one or more model property objects and one or more property values to create a client model, the client model being a representation of a server model for the persistence context comprising an initialized model property and an uninitialized model property; and
sending second model data to the client in response to receiving at least a second request from the client in at least a second operation between the client and the server within the same persistence context, the second model data comprising a property value for the uninitialized property for the client to expand the client model.

19. The computer-readable storage medium of claim 18, further comprising:
updating the server model within the same persistence context in response to receiving an update request from the client, the update request including update data for an update made to the client model.

20. The computer-readable storage medium of claim 18, wherein sending the first model data comprises:
assigning a model identifier to a new model object;
identifying from the first request a model property to be fetched;
identifying a model property object for the model property; and
retrieving a property value for the model property object.
